(19) United States
(12) Patent Application Publication
(10) Pub. No.: US 2015/0063321 A1
(43) Pub. Date: Mar. 5, 2015

(54) RADAR DETECTION

(71) Applicant: QUALCOMM Incorporated, San Diego, CO (US)

(72) Inventors: Ahmed Kamel SADEK, San Diego, CA (US); Mehmet YAVUZ, San Diego, CA (US)

(21) Appl. No.: 14/469,834

(22) Filed: Aug. 27, 2014

Related U.S. Application Data
(60) Provisional application No. 61/873,537, filed on Sep. 4, 2013.

(51) Int. Cl. H04L 5/00; H04W 72/04

(52) U.S. Cl. CPC H04L 5/0062; H04W 72/0446
USPC 370/336; 370/329

(57) ABSTRACT

Systems and methods for radar detection in a communication environment are disclosed. The radar detection may comprise, for example: receiving a first signal; identifying the first signal as a potential radar signal; limiting transmission by an apparatus as a result of the identification; receiving a second signal while the transmission by the apparatus is limited; and determining whether at least one of the first signal, the second signal, or a combination thereof is a radar signal.

### CROSS-REFERENCE TO RELATED APPLICATIONS

The present Application for Patent claims the benefit of U.S. Provisional Application No. 61/873,537, entitled “RADAR DETECTION,” filed Sep. 4, 2013, assigned to the assignee hereof, and expressly incorporated herein by reference in its entirety.

### INTRODUCTION

Aspects of this disclosure relate generally to telecommunications, and more particularly to radar detection and the like.

A wireless communication network may be deployed to provide various types of services (e.g., voice, data, multimedia services, etc.) to users within a coverage area of the network. In some implementations, one or more access points (e.g., corresponding to different cells) provide wireless connectivity for access terminals (e.g., cell phones) that are operating within the coverage of the access point(s). In some implementations, peer devices provide wireless connectively for communicating with one another.

Communication between devices in a wireless communication network may be subject to interference. For a communication from a first network device to a second network device, emissions of Radio Frequency (RF) energy by a nearby device may interfere with reception of signals at the second network device. For example, some wireless communication bands (e.g., a 5 GHz band or other bands) are subject to interference from radar systems operating within those bands.

Over-the-air radar detection is employed in some wireless communication networks in an attempt to mitigate radar interference. For example, an Unlicensed National Information Infrastructure (U-NII) network may employ a Dynamic Frequency Selection (DFS) function to: detect and avoid co-channel operation with radar systems; and provide, on aggregate, a uniform spreading of the operating channels across the entire band.

A U-NII device may operate in Master Mode or Client Mode. A Master initiates a U-NII network by transmitting control signals that will enable other U-NII devices to associate with the Master. A Client operates in a network controlled by a U-NII device operating in Master Mode.

FIG. 1 illustrates an example of channel availability and DFS requirements for several 5 GHz bands. For the U.S., Europe, and Japan, DFS is employed on channels 52-144. DFS might not be employed on the other channels.

In a U-NII network, radar detection is employed in certain channels in the 5 GHz band. A device and/or network operating on a channel where radar detection is called for will repeatedly (e.g., continually) monitor that channel (and, optionally, other available channels) for radar signals. In the event radar is detected, transmission is stopped.

FIG. 2 illustrates an example of a DFS sequence. These operations may be employed, for example, to detect radar waveforms having a received signal strength above a DFS Detection Threshold (e.g., −62 dBm).

Table 1 illustrates an example of DFS Response Requirement Values.

TABLE 1

| Parameter | Value |
|---|---|
| Non-Occupancy Period | Minimum 30 minutes |
| Channel Availability Check | 60 seconds |
| Time | |
| Channel Move Time | 10 seconds (see Note 1) |
| Channel Closing | 20 milliseconds + an aggregate of 60 |
| Transmission time | milliseconds over remaining 10 second |
| | period (see Note 1 & 2) |
| U-NII Detection Bandwidth | Minimum 80% of the U-NII 99% |
| | transmission power bandwidth (see Note |
| | 3) |

(Note 1): The instant that the Channel Move Time and the channel Closing Transmission Time begin is as follows: for the Short Pulse Radar Test Signals this instant is the end of the Burst; for the Frequency Hopping Radar Test Signal, this instant is the end of the last radar burst generated; for the Long Pulse Radar Test Signal this instant is the end of the 12 second period defining the Radar Waveform.
(Note 2): The Channel Closing Transmission time is comprised of 200 milliseconds starting at the beginning of the Channel Move Time plus any additional intermittent control signals required to facilitate a channel move (an aggregate of 60 millseconds) during the remainder of the 10 second period. The aggregate duration of control signals will not count quiet periods in between transmissions.
(Note 3): During the U-NII Detection Bandwidth detection test, radar type 1 is used. For each frequency step, the minimum percentage of detection is 90 percent. Measurements are performed with no data traffic.

In practice, radar detection by a device may be hampered when the device is communicating with another device. For example, radar detection might not be possible when the device is transmitting. Thus, for technologies such as LTE time division duplexing (TDD) that employ planned transmit and receive times (e.g., time slots) on the same frequency channel, the periods of time available for radar detection may be significantly limited (e.g., limited to those times when a device is not transmitting). For example, if the traffic duty cycle is relatively high (i.e., a high transmit to receive ratio), radar detection may be challenging due to the limited amount of time available to detect radar. Moreover, radar detection may be unreliable even during a receive mode (e.g., in cases where a device is simultaneously receiving data and attempting to detect radar).

### SUMMARY

Systems and methods for radar detection in a communication environment are disclosed.

A method of radar detection in a communication environment is disclosed. The method may comprise, for example: receiving a first signal; identifying the first signal as a potential radar signal; limiting transmission by an apparatus as a result of the identification; receiving a second signal while the transmission by the apparatus is limited; and determining whether at least one of the first signal, the second signal, or a combination thereof is a radar signal.

An apparatus for radar detection in a communication environment is also disclosed. The apparatus may comprise, for example, a receiver and a processor. The receiver may be configured to receive a first signal. The processor may be configured to identify the first signal as a potential radar signal, and limit transmission by an apparatus as a result of the identification. The receiver may be further configured to receive a second signal while the transmission by the apparatus is limited. The processor may be further configured to determine whether at least one of the first signal, the second signal, or a combination thereof is a radar signal.

Another apparatus for radar detection in a communication environment is also disclosed. The apparatus may comprise, for example: means for receiving a first signal; means for identifying the first signal as a potential radar signal; means for limiting transmission by an apparatus as a result of the identification; means for receiving a second signal while the transmission by the apparatus is limited; and means for determining whether at least one of the first signal, the second signal, or a combination thereof is a radar signal.

A computer-readable medium is also disclosed that comprises instructions, which, when executed by a processor, cause the processor to perform operations for radar detection in a communication environment. The computer-readable medium may comprise, for example: instructions for receiving a first signal; instructions for identifying the first signal as a potential radar signal; instructions for limiting transmission by an non-transitory computer-readable medium as a result of the identification; instructions for receiving a second signal while the transmission by the non-transitory computer-readable medium is limited; and instructions for determining whether at least one of the first signal, the second signal, or a combination thereof is a radar signal.

### BRIEF DESCRIPTION OF THE DRAWINGS

These and other sample aspects of the disclosure will be described in the detailed description and the claims that follow, and in the accompanying drawings.

FIG. 1 is a simplified diagram illustrating an example of DFS in a 5 GHz band.

FIG. 2 is a simplified diagram illustrating an example of a DFS sequence.

FIG. 3 is a simplified block diagram of several sample aspects of a communication system adapted to support multi-phase radar detection.

FIG. 4 is a simplified diagram illustrating an example of multi-phase radar detection.

FIG. 5 is a simplified diagram illustrating an example of radar types employing short pulses.

FIG. 6 is a simplified diagram illustrating an example of a radar type employing longer pulses.

FIG. 7 is a simplified diagram illustrating an example of a radar type employing frequency hopping.

FIG. 8 is a simplified diagram illustrating an example of UL and DL allocations.

FIG. 9 is a simplified diagram illustrating an example of sub-frame modeling.

FIG. 10 is flowchart of several sample aspects of operations that may be performed in conjunction with radar detection.

FIG. 11 is a simplified block diagram of several sample aspects of components that may be employed in communication nodes.

FIG. 12 is a simplified diagram of a wireless communication system.

FIG. 13 is a simplified diagram of a wireless communication system including small cells.

FIG. 14 is a simplified diagram illustrating coverage areas for wireless communication.

FIG. 15 is a simplified block diagram of several sample aspects of communication components.

FIG. 16 is a simplified block diagram of several sample aspects of an apparatus configured to support radar detection as taught herein.

In accordance with common practice, the various features illustrated in the drawings may not be drawn to scale. Accordingly, the dimensions of the various features may be arbitrarily expanded or reduced for clarity. In addition, some of the drawings may be simplified for clarity. Thus, the drawings may not depict all of the components of a given apparatus (e.g., device) or method. Finally, like reference numerals may be used to denote like features throughout the specification and figures.

### DETAILED DESCRIPTION

The disclosure relates in some aspects to techniques that provide more reliable radar detection. In this regard, a detection algorithm may generally incorporate two phases: 1) a pre-detection phase and 2) a final detection phase.

In some aspects, the pre-detection phase is a coarse detection phase that is used to trigger a finer final detection phase. Typically, the pre-detection phase makes a decision based on fewer samples (e.g., 10 samples) than the final detection phase. In this way, an initial detection of a radar signal may be made without using significant resources and may be made relatively quickly. Thus, initial detection may be invoked relatively frequently without significantly affecting system performance. However, the initial phase does not detect radar with the same level of accuracy as the final detection phase.

The final detection phase (e.g., a fine detection phase) is invoked if the pre-detection phase indicates the presence of a potential radar signal. To provide more effective radar detection during the final detection phase, transmissions by one or more devices are temporarily limited. For example, the scheduling of transmissions may be stopped, transmit power of a device may be reduced, the resources made available for transmissions may be restricted, channel quality reporting may be curtailed, a lower duty cycle may be employed, or a request to cease transmissions may be sent.

Once the transmission is limited, a more comprehensive analysis of received signals is performed to determine whether radar signals are in fact being received. For example, a device may analyze a relatively large number of received samples (e.g., 100 samples) to determine whether the samples correspond to radar pulses. If radar is indicated, communication operations may be switched to a different communication channel to avoid the radar.

Advantageously, through the use of the pre-detection phase, a device may detect radar in an opportunistic manner. For example, rather than rely on a fixed transmit and receive cycle whereby radar is only detected during the fixed receive times, the duty cycle for full radar detection may be adjusted depending on whether it appears that radar may be present. If the presence of radar is suspected based on the pre-detection phase, an upcoming transmit operation or receive may be pre-empted to enable more effective radar detection. For example, during a scheduled transmit cycle, a device may temporarily cease transmission (e.g., pilots and/or data traffic) and, instead, monitor for radar signals. As another example, during a scheduled receive cycle, a first device may cause an associated second device to temporarily cease transmission to the first device so that the first device may, instead, monitor for radar signals.

Accordingly, a system implemented in accordance with the teachings herein may dynamically adapt its operations to account for radar, when present, yet provide normal operations when radar is not present. Thus, overall, such a system may provide a desired level of service (e.g., a desired overall duty cycle) while still providing effective radar detection.

Various aspects of the disclosure are described below. It should be apparent that the teachings herein may be embodied in a wide variety of forms and that any specific structure, function, or both being disclosed herein is merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. Furthermore, any aspect disclosed herein may be embodied by one or more elements of a claim. For convenience, the term ‘some aspects’ may be used herein to refer to a single aspect or multiple aspects of the disclosure.

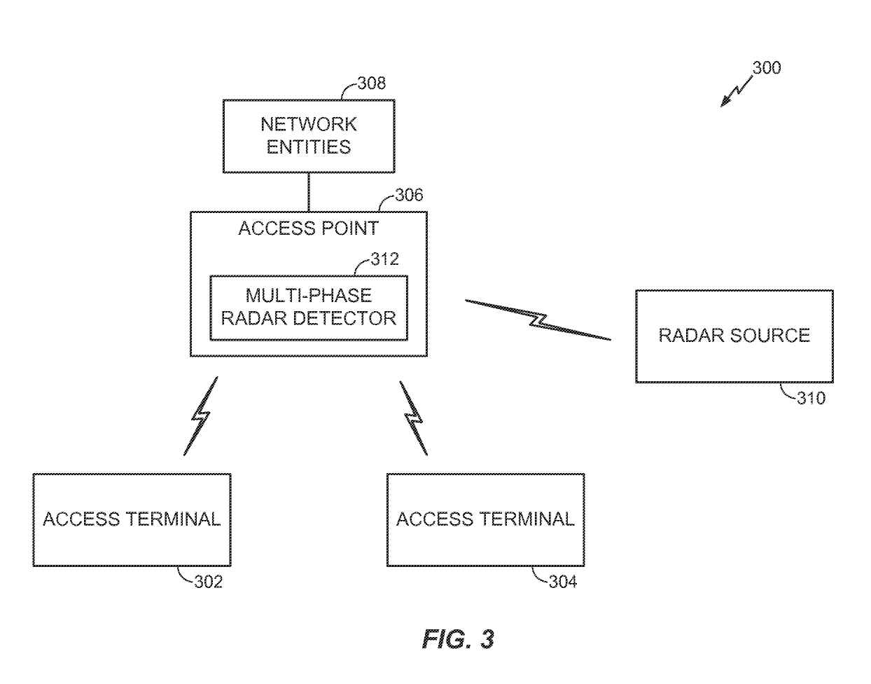

FIG. 3 illustrates several nodes of a sample communication system 300 (e.g., a portion of a communication network). For illustration purposes, various aspects of the disclosure will be described in the context of one or more access terminals, access points, and network entities that communicate with one another. It should be appreciated, however, that the teachings herein may be applicable to other types of apparatuses or other similar apparatuses that are referenced using other terminology. For example, in various implementations access points may be referred to or implemented as base stations, NodeBs, eNodeBs, Home NodeBs, Home eNodeBs, small cells, macro cells, and so on, while access terminals may be referred to or implemented as user equipment (UEs), mobile stations, and so on.

Access points in the system 300 provide access to one or more services (e.g., network connectivity) for one or more wireless terminals (e.g., the access terminal 302 or the access terminal 304) that may be installed within or that may roam throughout a coverage area of the system 300. For example, at various points in time the access terminal 302 may connect to the access point 306 or some other access point in the system 300 (not shown). Similarly, the access terminal 304 may connect to the access point 306 or some other access point.

Each of the access points may communicate with one or more network entities (represented, for convenience, by the network entities 308), including each other, to facilitate wide area network connectivity. Two or more of such network entities may be co-located and/or two or more of such network entities may be distributed throughout a network.

A network entity may take various forms such as, for example, one or more radio and/or core network entities. Thus, in various implementations the network entities 308 may represent functionality such as at least one of: network management (e.g., via an operation, administration, management, and provisioning entity), call control, session management, mobility management, gateway functions, interworking functions, or some other suitable network functionality. In some aspects, mobility management relates to: keeping track of the current location of access terminals through the use of tracking areas, location areas, routing areas, or some other suitable technique; controlling paging for access terminals; and providing access control for access terminals.

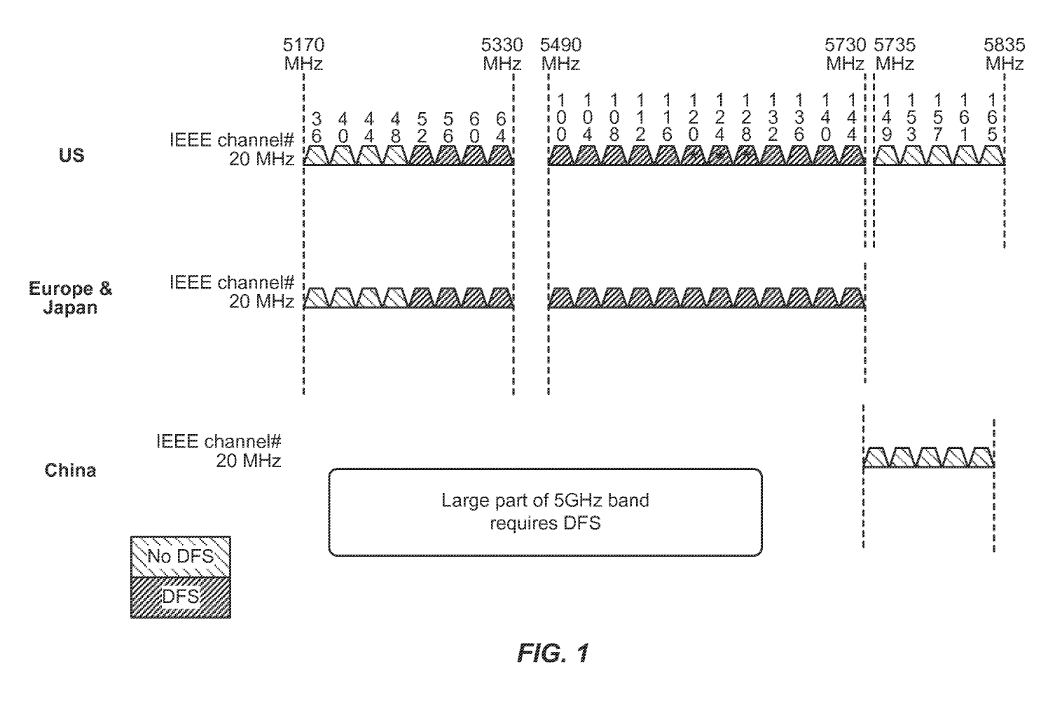

As indicated above with reference to FIG. 1, reception of wireless signals at the access point 306 (or any other devices in the system 300) may be subjected to interference from a radar source 310. In accordance with the teachings herein, the access point 306 includes a multi-phase radar detector 312 that provides opportunistic radar detection.

In some implementations, the radar detector 312 employs a radar detection algorithm including an initial detection (e.g., pre-detection) phase and a final detection phase. The initial detection phase determines whether the access point 306 has received a potential radar signal. For example, the radar detector 312 may repeatedly (e.g., periodically) sample received signals and process those signals in an efficient manner to make a preliminary determination as to whether the received signals are radar signals. If the received signals appear to be radar signals, the final detection phase is invoked. During this latter phase, a more robust analysis of received signals is performed in an attempt to determine, with more certainty, whether the access point 306 is in fact receiving radar signals. As discussed herein, to facilitate the more accurate radar detection of the final phase, transmissions of the access point 306 and/or any devices associated with the access point 306 (e.g., the access terminals 302 and 304) may be limited.

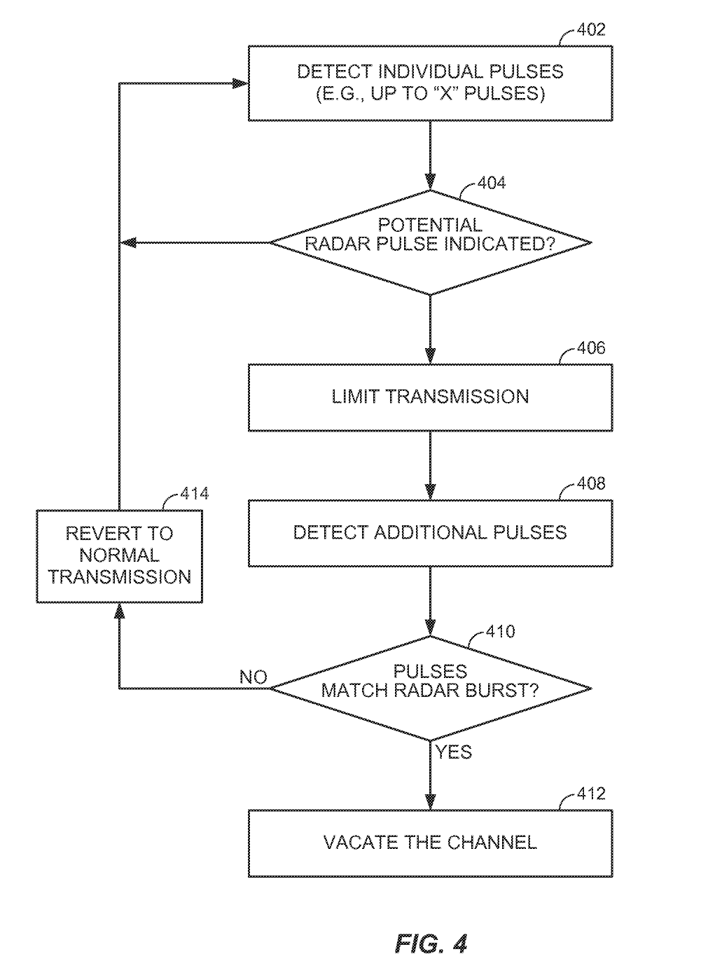

FIG. 4 illustrates an example of a radar detection algorithm. For convenience, the operations of FIG. 4 (or any other operations discussed or taught herein) may be described as being performed by specific components. It should be appreciated, however, that these operations may be performed by other types of components and may be performed using a different number of components. For example, the algorithm of FIG. 4 may be implemented by an access point, and access terminal, or some other type of device. It also should be appreciated that one or more of the operations described herein may not be employed in a given implementation.

As represented by block 402, an initial (pre-detection) phase of the algorithm involves individual pulse detection. For example, a receiver may collect up to “x” samples and process each sample to determine whether any of the samples correspond to radar pulses. Thus, in some aspects, the initial detection phase may employ one or more triggers such as determining whether “x” number of radar pulses having certain radar-like characteristics have been received. The parameter “x” and the trigger thresholds may be selected to tradeoff detection probability and false alarms.

In some implementations, pulse detection involves detecting a rising edge of in-band power, checking the one or more characteristics of a received pulse to determine whether the characteristic matches (or the characteristics match) one or more characteristics of a radar pulse, and continuing the caparison until the falling edge of the in-band power.

The above characteristics may include, for example, RSSI, pulse width, pulse repetition interval, pulse bandwidth, pulse timing, pulse frequency, whether a received signal is a chirp signal, and so on.

As represented by block 404, the final detection phase is invoked if initial detection phase triggers are met. If the detection of block 402 does not indicate that a potential radar pulse has been received, the operational flow proceeds back to block 402 so that the detection operations of the initial phase (pre-detection) may continue. Conversely, if the detection of block 402 indicates that a potential radar pulse has been received, the operational flow proceeds to blocks 406 and 408 of the final detection phase.

At block 406, the transmission of one or more devices is limited as discussed herein. For example, transmissions by a device may be stopped, transmit power may be reduced, transmit duty cycle may be reduced, and so on.

At block 408, additional pulses are detected while the transmission is limited. For example, a device may collect ten times more samples than were collected at block 402.

As represented by block 410, a determination is made as to whether the detected pulses (e.g., from blocks 402 and 408) correspond to radar signals. For example, collections of received pulses may be compared with known radar burst types to determine whether there is a match (e.g., within given probability).

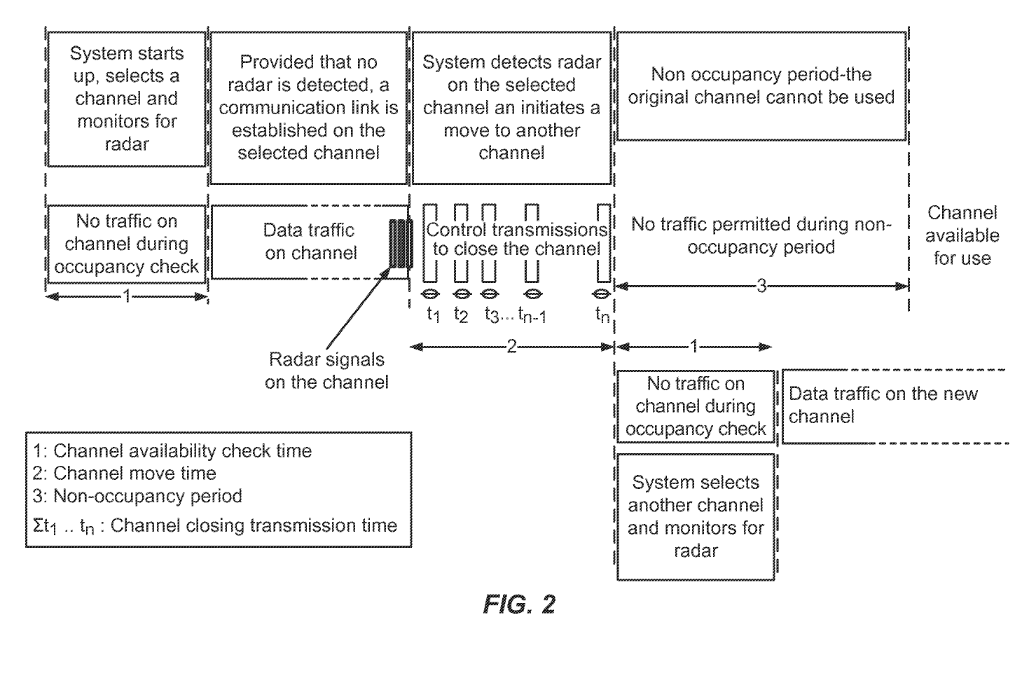

As represented by block 412, if there is a match at block 410, the device vacates the channel due to the presence of radar on that channel. For example, according to the procedure of FIG. 2, the device will stop transmission on the channel for at least the non-occupancy period (optionally moving to another channel).

Conversely, if a match was not indicated at block 410 (e.g., the initial detection phase results in a false alarm), the operational flow proceeds back to block 402 so that the detection operations of the initial phase may resume.

As represented by block 414, prior to resuming the initial detection phase, any transmission that was limited at block 406 reverts back to normal transmission. For example, transmissions that were stopped may be restarted, transmit power may be increased, transmit duty cycle may be increased, and so on.

Various techniques may be employed in accordance with the teachings herein to limit transmission (and thereby improve the analysis of the received signals) during the final detection phase. Several examples considered from the perspective of an access point are set forth below. A given implementation may employ one or more of these (or other suitable) techniques.

Also, operations comparable to those set forth below may be performed by another type of device for implementations where this other type of device performs radar detection. For example, in some implementations (e.g., an LTE direct implementation employing direct UE-to-UE communication), an access terminal may perform radar detection. In such a case, designations such as uplink (UL) and downlink (DL) might not be applicable, the manner of scheduling, power control, and resource allocation may be different, and the signaling may be different.

In some implementations, a device may stop scheduling a future transmission in order to enable observing more radar pulses. In addition, a device may stop a transmission that was previously scheduled (e.g., autonomously deny an upcoming scheduled transmission).

In some implementations, a device may stop scheduling grants (e.g., UL grants) to associated clients in order to stop receiving, and hence reduce interference during the reception time.

In some implementations, a device may trigger power control (e.g., UL power control) to reduce client transmit power. In some implementations, a device may trigger power control to reduce overall operating Interference over Thermal Noise (IoT). For example, transmit power of an associated device may be reduced (instead of stopping transmissions entirely) in implementations that are capable of detecting radar while receiving traffic signals.

In some implementations, a device may restrict resources (e.g., UL resources) scheduled to be on a channel edge. In this way, narrow band radar pulse detection may be enabled in the middle of the band.

In some implementations, a device may switch from periodic channel quality indication (CQI) operations (e.g., reporting) to aperiodic CQI operations.

In some implementations, a device may switch to a different time division duplexing (TDD) configuration that has a lower transmit/listen duty cycle. For example, Config. 0 in LTE TDD may be configured to have fewer transmit (e.g., DL) sub-frames than receive (e.g., UL) sub-frames.

For a Wi-Fi (e.g., 801.11-based) access point, the access point can transmit a message to stop transmissions from associated clients or nearby nodes for better detection probability. For example, the access point may transmit a quiet period request or clear-to-send-to-self (CTS2S) message.

In the example of FIG. 3, the access point 306 is depicted as including the radar detector 312. In different implementations, some or all of the functionality of the radar detector 312 may be embodied in different entities. For example, in some implementations, an access terminal may employ radar detection.

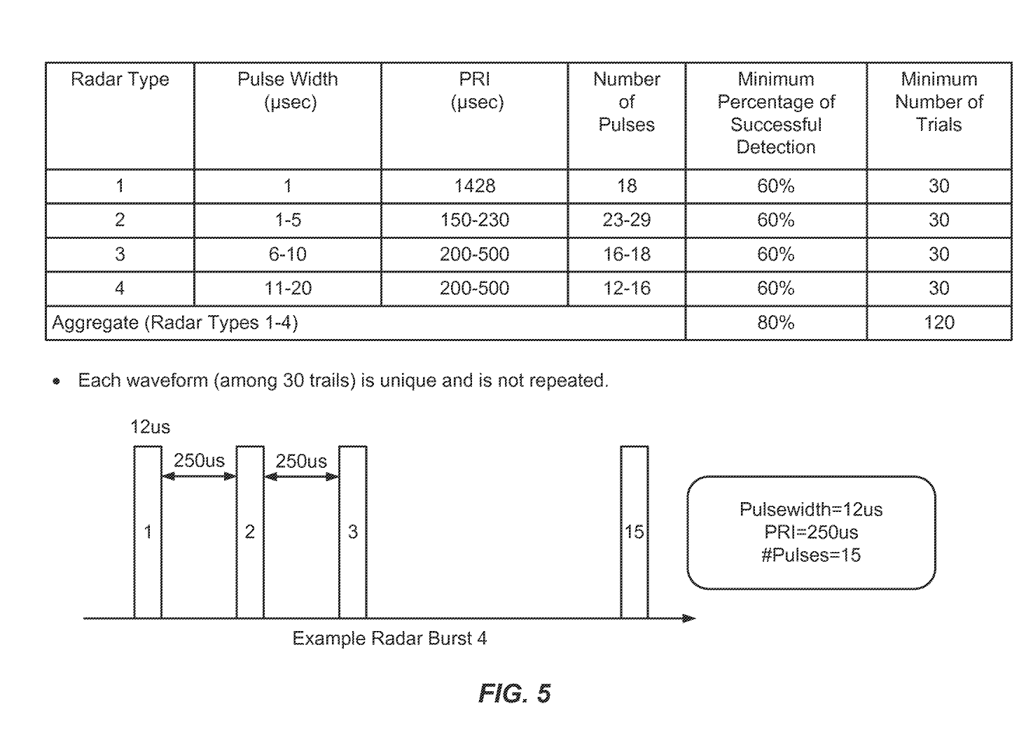

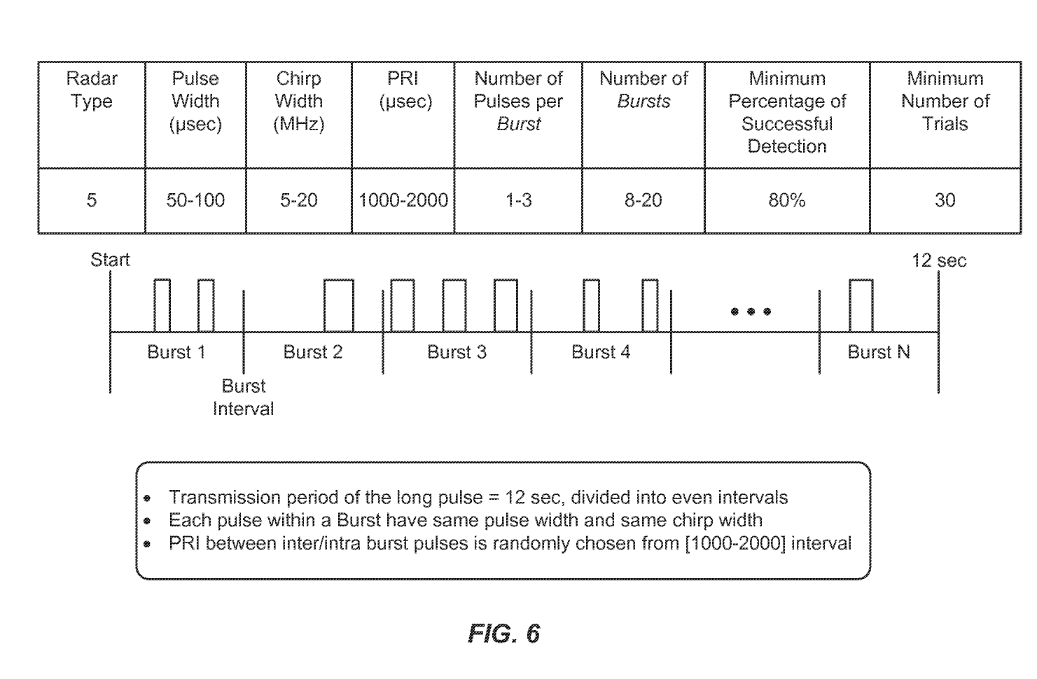

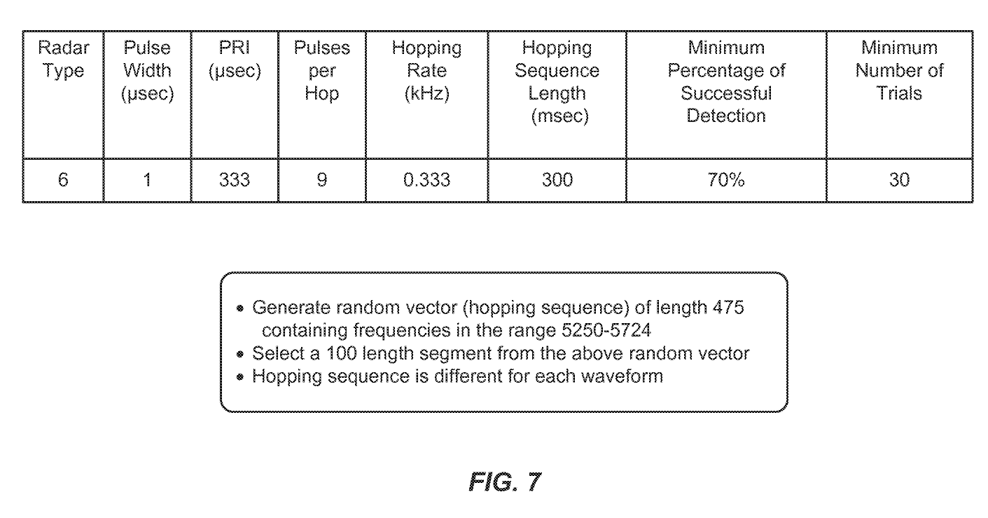

FIGS. 5-7 illustrate examples of characteristics associated with radar pulses that may be subject to detection. FIG. 5 illustrates examples of four radar types employing short pulses. FIG. 6 illustrates examples of a radar type employing longer pulses. FIG. 7 illustrates examples of a radar type employing frequency hopping.

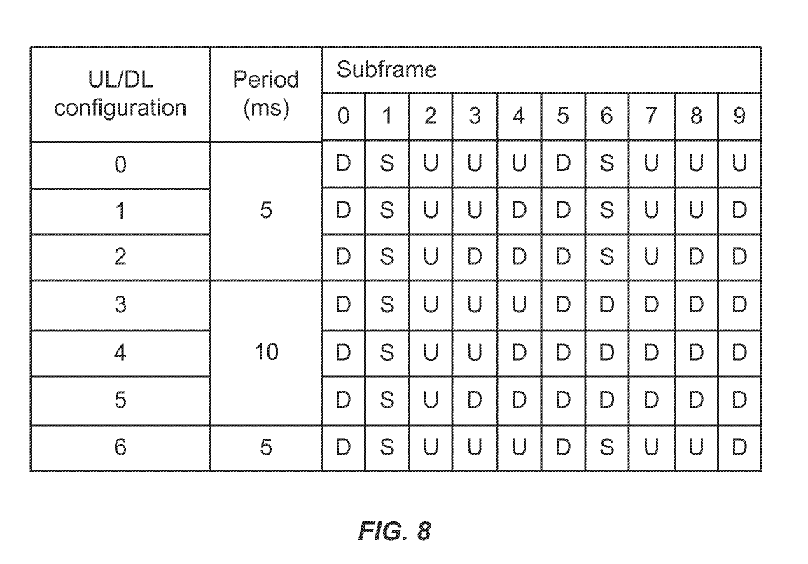

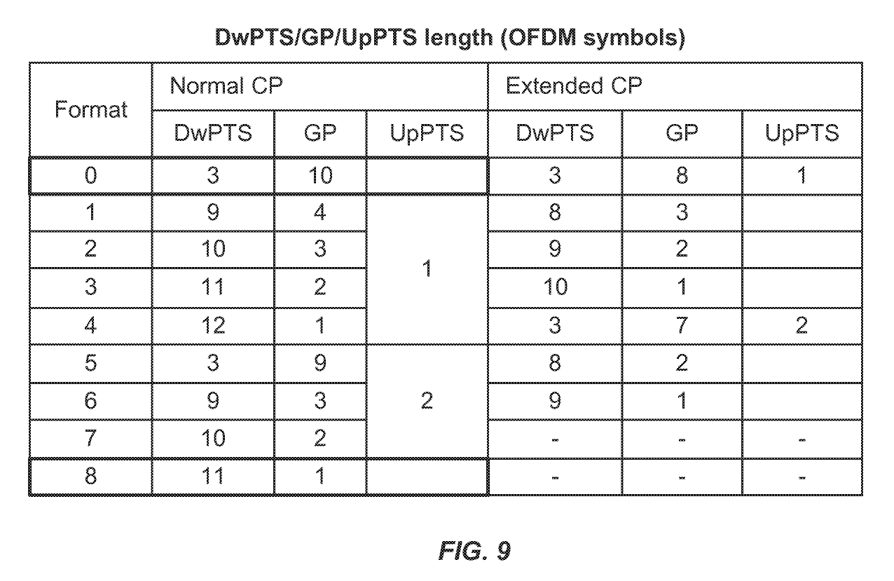

An example of DFS performance will now be treated from the perspective of an access point (e.g., an eNodeB) with reference to FIGS. 8 and 9. In this example, it is assumed that the access terminals (e.g., UEs) associated with the access point are clients that are not performing DFS. In other implementations, an access terminal (or some other type of entity) may perform DFS.

FIG. 8 illustrates an example of UL and DL allocations for a TDD network. Here, “U” refers to a UL sub-frame, “D” refers to a DL sub-frame, and “S” refers to a special sub-frame. The special sub-frame follows a DL sub-frame and precedes a UL sub-frame. In some aspects, the special sub-frame facilitates a transition from transmitting (during DL) to receiving (during UL). This figure illustrates that for certain configurations there is a very limited number of UL sub-frames that could be used for radar detection (e.g., at an access point).

The teachings herein may be employed to improve radar detection for such configurations. For example, if a pre-detection phase (e.g., conducted during an UL sub-frame or a S sub-frame) for an access point indicates possible radar, the access point may acquire and process additional samples during subsequent sub-frames. In the event a subsequent sub-frame is a DL sub-frame, the access point can refrain from transmitting to enable sampling of potential radar signals. In the event a subsequent sub-frame is an UL sub-frame, the access point can request that its client(s) refrain from transmitting to enable the access point to better sample potential radar signals.

FIG. 9 illustrates an example of modeling for a special sub-frame for an LTE TDD system. The analysis that follows assumes radar detection is possible during an UL and a guard period (GP).

The numbers in the table indicate the length of the corresponding entry in terms of ODFM symbols, for a normal cyclic prefix (CP) case and an extended CP case. Here, DwPTS refers to a downlink pilot time slot, UpPTS refers to an uplink pilot time slot, and GP refers to a guard period.

Two extremes are illustrated in FIG. 9. The first extreme is based on 3 DL, 10 GP, and 1 UL periods as indicated in the Format 0 row. This is an example of an upper bound on radar detection performance. The second extreme is based on 11 DL, 1 GP, and 2 UL periods as indicated in the Format 8 row. This is an example of an upper bound on radar detection performance. In general, there is a higher probability of radar detection for the upper bound case as compared to the lower bound case.

Initially, several algorithm and modeling assumptions are presented. Pulses received during downlink transmissions (e.g., of an LTE waveform) are not detected.

In some implementations, a counter may be maintained for the number of accepted pulses during final radar detection. This counter is reset based on the pulse repetition interval (PRI) window (e.g., the time elapsed before receiving a new pulse). This may be done, for example, to avoid false alarms. As one example, the PRI window may be set equal to 4*PRI. The PRI window may be frozen during the DL time (e.g., LTE DL time). Thus, DL timing is taken into account. Such a counter may be advantageously used to track pulses over a number of UL sub-frames, irrespective of whether a DL sub-frame occurs during the UL sub-frames.

In some implementations, the number of accepted pulses is counted and then compared to a threshold to decide if radar is detected.

Additional improvements in DFS (e.g., for LTE TDD) may be achieved through the use of the teachings herein. For example, a device may opportunistically stop DL transmission and continue listening when “x” radar pulses are detected. Here, x is less than (e.g., by an order of magnitude) the threshold number of pulses needed to declare radar (e.g., during the final phase). In some aspects, this scheme may help reduce misdetection due to scenarios when radar starts just before DL starts. The quantity “x” may be optimized to tradeoff misdetection and false alarms.

As an example of such a DFS enhancement, the probability of radar detection for LTE TDD Config. 1 may increase from 27% to 95%.

In the event an access point does not have any available gaps (in time) to listen for radar, an access point acting as a Master can delegate a Client to perform In Service Monitoring. If there is no access terminal (e.g., UE) associated with the Master, the Master may perform In Service monitoring in order to send synchronization and broadcast channels (e.g., SYNC, BCH). Opportunistic operation as taught herein may be used to introduce quiet times for detecting radar.

For an access terminal to support DFS, new signaling may be employed. For example, an access point (e.g., eNB) may send a request for an access terminal to perform In Service Monitoring. In addition, an access terminal may send a message to inform the access point that radar has been detected. The above operations may be performed by one or more access terminals.

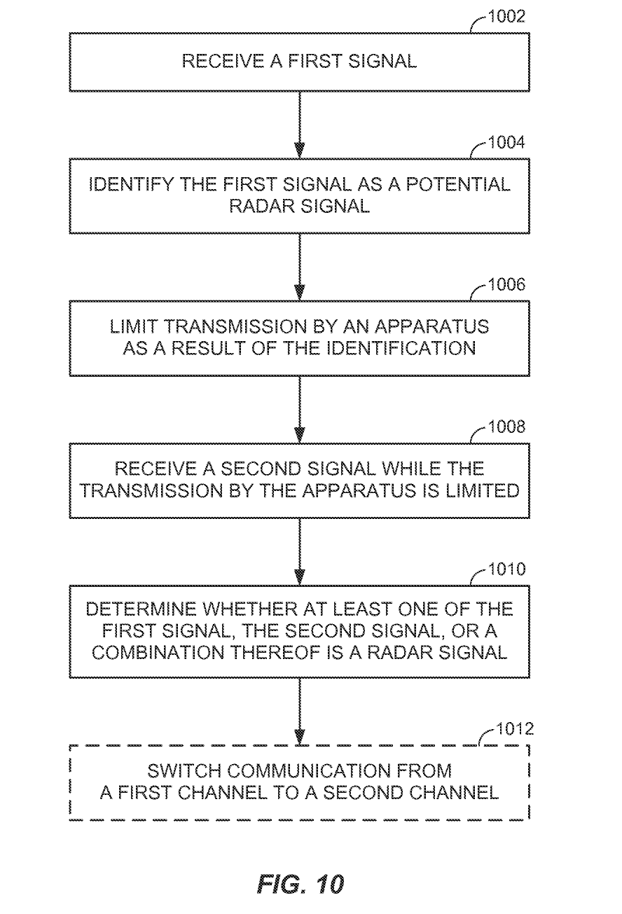

With the above in mind, sample operations relating to radar detection will be described in more detail in conjunction with the flowchart of FIG. 10. These operations may be implemented by an access point, an access terminal, or some other type of apparatus.

As represented by block 1002 of FIG. 10, a first signal is received. An apparatus may monitor for RF signals on one or more channels to determine whether any signals are being received. For example, the apparatus may periodically invoke an initial detection phase of a radar detection algorithm that processes received signals to determine whether the radar signals are being received.

As represented by block 1004, the first signal is identified as a potential radar signal. For example, during the initial detection phase, one or more characteristics of the first signal may be compared to one or more known characteristics of radar signals. If the comparison indicates a potential match (e.g., a correlation above a defined threshold), a determination is made that the first signal is a potential radar signal.

In some aspects, the identification of the first signal as a potential radar signal may comprise detecting at least one potential radar pulse.

In some aspects, the identification of the first signal as a potential radar signal may comprise a preliminary determination that radar signals are being received.

In some aspects, the identification of the first signal as a potential radar signal may comprise determining whether a defined quantity of pulses were received within a defined period of time.

In some aspects, the identification of the first signal as a potential radar signal may comprise at least one of: determining whether a bandwidth characteristic of the first signal corresponds to a bandwidth characteristic of a radar pulse; or determining whether a frequency characteristic of the first signal corresponds to a frequency characteristic of a radar pulse.

In some aspects, the identification of the first signal as a potential radar signal may comprise at least one of: determining whether a received signal strength characteristic of the first signal corresponds to a received signal strength characteristic of a radar signal; determining whether a pulse width characteristic of the first signal corresponds to a pulse width characteristic of a radar signal; determining whether a pulse repetition interval characteristic of the first signal corresponds to a pulse repetition interval characteristic of a radar signal; or determining whether a chirp characteristic of the first signal corresponds to a chirp characteristic of a radar signal.

As represented by block 1006, transmission by an apparatus is limited as a result of the identification of block 1004. As discussed herein, a final (fine) radar detection phase may be invoked based on a trigger generated by the initial radar detection phase. The operations of block 1006 may involve, for example, taking action to temporarily prevent an apparatus from transmitting for a period of time, temporarily restrict how often the apparatus transmits, temporarily restrict the resources available to the apparatus for transmitting, or temporarily limit transmission in some other manner.

In some aspects, the limitation of transmission may comprise transmitting a message to the apparatus requesting that the apparatus limit transmission. For example, an apparatus may transmit a quiet period request, a CTS2S message, an UL power control message, or some other suitable type of message.

In some aspects, the limitation of transmission may comprise at least one of: ceasing scheduling of transmissions for the apparatus; ceasing issuance of grants in response to requests to schedule transmissions received from the apparatus; reducing transmit power of the apparatus; limiting resources for transmissions by the apparatus; switching from periodic channel quality reporting to aperiodic channel quality reporting; or reducing transmit-to-receive duty cycle for time division duplex communication.

The transmission of one or more apparatuses may be limited at block 1006. For example, transmission by an apparatus that is performing the operations of FIG. 10 may be limited (e.g., an access point takes action to limit its DL transmissions). As another example, transmission by a second apparatus that communicates with a first apparatus that is performing the operations of FIG. 10 may be limited (e.g., an access point takes action to limit the UL transmissions of a served access terminal). As yet another example, an access point may take action to limit its transmission and the transmission of its served access terminals.

As represented by block 1008, a second signal is received while the transmission by the apparatus is limited. For example, during a period of time when an apparatus and its associated apparatuses have stopped transmitting, the apparatus may monitor for RF signals on one or more channels. In this way, the apparatus may more effectively collect samples for the second phase of the radar detection process.

As represented by block 1010, a determination is then made as to whether at least one of the first signal, the second signal, or a combination thereof is a radar signal. For example, the apparatus may process any received signals to determine whether any of the signals received at block 1008 are radar signals

In some aspects, the determination of whether at least one of the first signal, the second signal, or a combination thereof is a radar signal may comprise detecting a radar pulse burst pattern.

In some aspects, the determination of whether at least one of the first signal, the second signal, or a combination thereof is a radar signal may comprise a final determination that radar signals are being received.

In some aspects, the determination of whether at least one of the first signal, the second signal, or a combination thereof is a radar signal may comprise determining whether a defined quantity of pulses were received within a defined period of time.

In some aspects, the determination of whether at least one of the first signal, the second signal, or a combination thereof is a radar signal may comprise at least one of: determining whether a bandwidth characteristic of the first signal, the second signal, or a combination thereof corresponds to a bandwidth characteristic of a radar pulse; or determining whether a frequency characteristic of the first signal, the second signal, or a combination thereof corresponds to a frequency characteristic of a radar pulse.

In some aspects, the determination of whether at least one of the first signal, the second signal, or a combination thereof is a radar signal may comprise at least one of: determining whether a received signal strength characteristic of the first signal, the second signal, or a combination thereof corresponds to a received signal strength characteristic of a radar signal; determining whether a pulse width characteristic of the first signal, the second signal, or a combination thereof corresponds to a pulse width characteristic of a radar signal; determining whether a pulse repetition interval characteristic of the first signal, the second signal, or a combination thereof corresponds to a pulse repetition interval characteristic of a radar signal; or determining whether a chirp characteristic of the first signal, the second signal, or a combination thereof corresponds to a chirp characteristic of a radar signal.

As represented by optional block 1012, based on the determination of block 1010, communication may be switched from a first channel to a second channel, or some other action may be taken as appropriate. For example, if an apparatus detects a radar signal on the channel currently being used by the apparatus for communication, the apparatus may elect to switch to another channel.

In some implementations, the operations of FIG. 10 may be employed to detect radar on a current operating channel as well as on one or more other channels. For example, an apparatus may monitor other channels to determine whether there is radar on those channels. In this way, in the event the apparatus needs to switch channels (e.g., due to radar on a current operating channel), the apparatus may select a new channel that does not have (or has not recently had) radar interference.

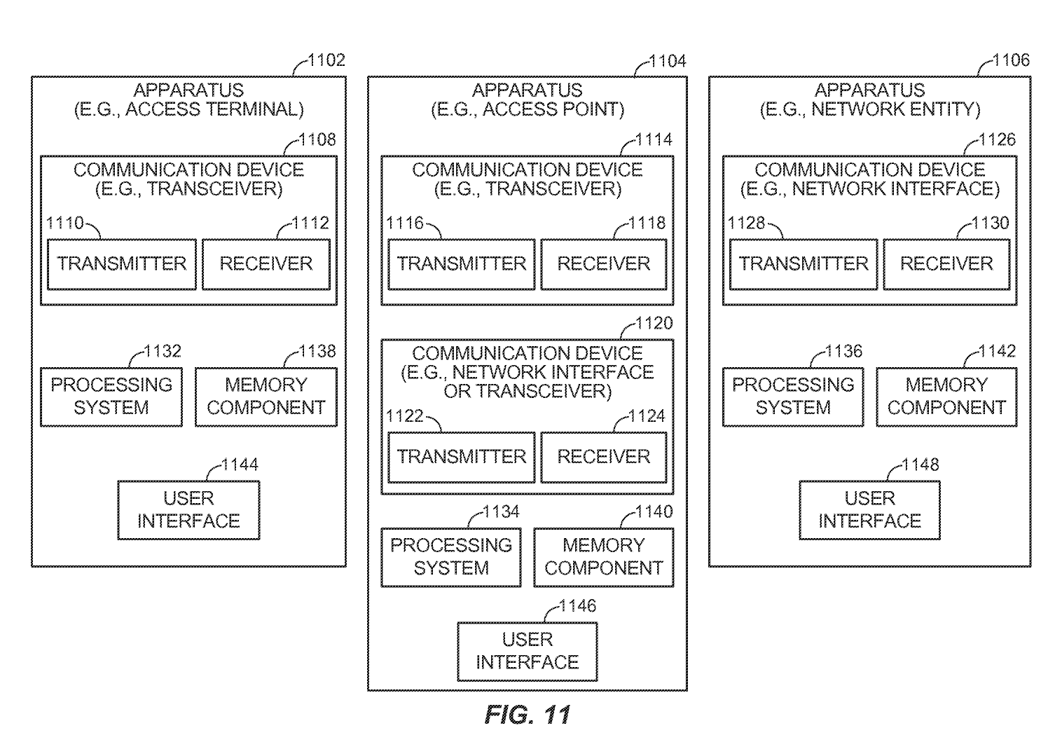

FIG. 11 illustrates several sample components (represented by corresponding blocks) that may be incorporated into an apparatus 1102, an apparatus 1104, and an apparatus 1106 (e.g., corresponding to an access terminal, an access point, and a network entity, respectively) to support radar detection operations as taught herein. It should be appreciated that these components may be implemented in different types of apparatuses in different implementations (e.g., in an ASIC, in an SoC, etc.). The described components also may be incorporated into other apparatuses in a communication system. For example, other apparatuses in a system may include components similar to those described to provide similar functionality. Also, a given apparatus may contain one or more of the described components. For example, an apparatus may include multiple transceiver components that enable the apparatus to operate on multiple carriers and/or communicate via different technologies.

The apparatus 1102 and the apparatus 1104 each include at least one wireless communication device (represented by the communication devices 1108 and 1114 (and the communication device 1120 if the apparatus 1104 is a relay)) for communicating with other nodes via at least one designated radio access technology. Each communication device 1108 includes at least one transmitter (represented by the transmitter 1110) for transmitting and encoding signals (e.g., messages, indications, information, and so on) and at least one receiver (represented by the receiver 1112) for receiving and decoding signals (e.g., messages, indications, information, pilots, and so on). Similarly, each communication device 1114 includes at least one transmitter (represented by the transmitter 1116) for transmitting signals (e.g., messages, indications, information, pilots, and so on) and at least one receiver (represented by the receiver 1118) for receiving signals (e.g., messages, indications, information, and so on). If the apparatus 1104 is a relay access point, each communication device 1120 may include at least one transmitter (represented by the transmitter 1122) for transmitting signals (e.g., messages, indications, information, pilots, and so on) and at least one receiver (represented by the receiver 1124) for receiving signals (e.g., messages, indications, information, and so on).

A transmitter and a receiver may comprise an integrated device (e.g., embodied as a transmitter circuit and a receiver circuit of a single communication device) in some implementations, may comprise a separate transmitter device and a separate receiver device in some implementations, or may be embodied in other ways in other implementations. In some aspects, a wireless communication device (e.g., one of multiple wireless communication devices) of the apparatus 1104 comprises a network listen module.

The apparatus 1106 (and the apparatus 1104 if it is not a relay access point) includes at least one communication device (represented by the communication device 1126 and, optionally, 1120) for communicating with other nodes. For example, the communication device 1126 may comprise a network interface that is configured to communicate with one or more network entities via a wire-based or wireless backhaul. In some aspects, the communication device 1126 may be implemented as a transceiver configured to support wire-based or wireless signal communication. This communication may involve, for example, sending and receiving: messages, parameters, or other types of information. Accordingly, in the example of FIG. 11, the communication device 1126 is shown as comprising a transmitter 1128 and a receiver 1130. Similarly, if the apparatus 1104 is not a relay access point, the communication device 1120 may comprise a network interface that is configured to communicate with one or more network entities via a wire-based or wireless backhaul. As with the communication device 1126, the communication device 1120 is shown as comprising a transmitter 1122 and a receiver 1124.

The apparatuses 1102, 1104, and 1106 also include other components that may be used in conjunction with radar detection operations as taught herein. The apparatus 1102 includes a processing system 1132 for providing functionality relating to, for example, radar detection as taught herein and for providing other processing functionality. The apparatus 1104 includes a processing system 1134 for providing functionality relating to, for example, radar detection as taught herein and for providing other processing functionality. The apparatus 1106 includes a processing system 1136 for providing functionality relating to, for example, radar detection as taught herein and for providing other processing functionality. The apparatuses 1102, 1104, and 1106 include memory devices 1138, 1140, and 1142 (e.g., each including a memory device), respectively, for maintaining information (e.g., information indicative of reserved resources, thresholds, parameters, and so on). In addition, the apparatuses 1102, 1104, and 1106 include user interface devices 1144, 1146, and 1148, respectively, for providing indications (e.g., audible and/or visual indications) to a user and/or for receiving user input (e.g., upon user actuation of a sensing device such as a keypad, a touch screen, a microphone, and so on).

For convenience, the apparatus 1102 is shown in FIG. 11 as including components that may be used in the various examples described herein. In practice, the illustrated blocks may have different functionality in different aspects. For example, functionality of the block 1134 for supporting the radar of FIG. 5 may be different as compared to functionality of the block 1134 for supporting the radar of FIG. 6.

The components of FIG. 11 may be implemented in various ways. In some implementations, the components of FIG. 11 may be implemented in one or more circuits such as, for example, one or more processors and/or one or more ASICs (which may include one or more processors). Here, each circuit may use and/or incorporate at least one memory component for storing information or executable code used by the circuit to provide this functionality. For example, some or all of the functionality represented by blocks 1108, 1132, 1138, and 1144 may be implemented by processor and memory component(s) of the apparatus 1102 (e.g., by execution of appropriate code and/or by appropriate configuration of processor components). Similarly, some or all of the functionality represented by blocks 1114, 1120, 1134, 1140, and 1146 may be implemented by processor and memory component(s) of the apparatus 1104 (e.g., by execution of appropriate code and/or by appropriate configuration of processor components). Also, some or all of the functionality represented by blocks 1126, 1136, 1142, and 1148 may be implemented by processor and memory component(s) of the apparatus 1106 (e.g., by execution of appropriate code and/or by appropriate configuration of processor components).

As mentioned above, some of the access points referred to herein may comprise small cell access points. As used herein, the term small cell access point refers to an access point having a transmit power (e.g., one or more of: maximum transmit power, instantaneous transmit power, nominal transmit power, average transmit power, or some other form of transmit power) that is less than a transmit power (e.g., as defined above) of any macro access point in the coverage area. In some implementations, each small cell access point has a transmit power (e.g., as defined above) that is less than a transmit power (e.g., as defined above) of the macro access point by a relative margin (e.g., 10 dBm or more). In some implementations, small cell access points such as femto cells may have a maximum transmit power of 20 dBm or less. In some implementations, small cell access points such as pico cells may have a maximum transmit power of 24 dBm or less. It should be appreciated, however, that these or other types of small cell access points may have a higher or lower maximum transmit power in other implementations (e.g., up to 1 Watt in some cases, up to 10 Watts in some cases, and so on).

Typically, small cell access points connect to the Internet via a broadband connection (e.g., a digital subscriber line (DSL) router, a cable modem, or some other type of modem) that provides a backhaul link to a mobile operator's network. Thus, a small cell access point deployed in a user's home or business provides mobile network access to one or more devices via the broadband connection.

Small cells may be configured to support different types of access modes. For example, in an open access mode, a small cell may allow any access terminal to obtain any type of service via the small cell. In a restricted (or closed) access mode, a small cell may only allow authorized access terminals to obtain service via the small cell. For example, a small cell may only allow access terminals (e.g., so called home access terminals) belonging to a certain subscriber group (e.g., a closed subscriber group (CSG)) to obtain service via the small cell. In a hybrid access mode, alien access terminals (e.g., non-home access terminals, non-CSG access terminals) may be given limited access to the small cell. For example, a macro access terminal that does not belong to a small cell's CSG may be allowed to access the small cell only if sufficient resources are available for all home access terminals currently being served by the small cell.

Thus, small cells operating in one or more of these access modes may be used to provide indoor coverage and/or extended outdoor coverage. By allowing access to users through adoption of a desired access mode of operation, small cells may provide improved service within the coverage area and potentially extend the service coverage area for users of a macro network.

Thus, in some aspects the teachings herein may be employed in a network that includes macro scale coverage (e.g., a large area cellular network such as a 3G network, typically referred to as a macro cell network or a wide area network (WAN)) and smaller scale coverage (e.g., a residence-based or building-based network environment, typically referred to as a local area network (LAN)). As an access terminal moves through such a network, the access terminal may be served in certain locations by access points that provide macro coverage while the access terminal may be served at other locations by access points that provide smaller scale coverage. In some aspects, the smaller coverage nodes may be used to provide incremental capacity growth, in-building coverage, and different services (e.g., for a more robust user experience).

In the description herein, a node (e.g., an access point) that provides coverage over a relatively large area may be referred to as a macro access point while a node that provides coverage over a relatively small area (e.g., a residence) may be referred to as a small cell. It should be appreciated that the teachings herein may be applicable to nodes associated with various types of coverage areas. For example, a pico access point may provide coverage (e.g., coverage within a commercial building) over an area that is smaller than a macro area and larger than a femto cell area. In various applications, other terminology may be used to reference a macro access point, a small cell, or other access point-type nodes. For example, a macro access point may be configured or referred to as an access node, base station, access point, eNodeB, macro cell, and so on. In some implementations, a node may be associated with (e.g., referred to as or divided into) one or more cells or sectors. A cell or sector associated with a macro access point, a femto access point, or a pico access point may be referred to as a macro cell, a femto cell, or a pico cell, respectively.

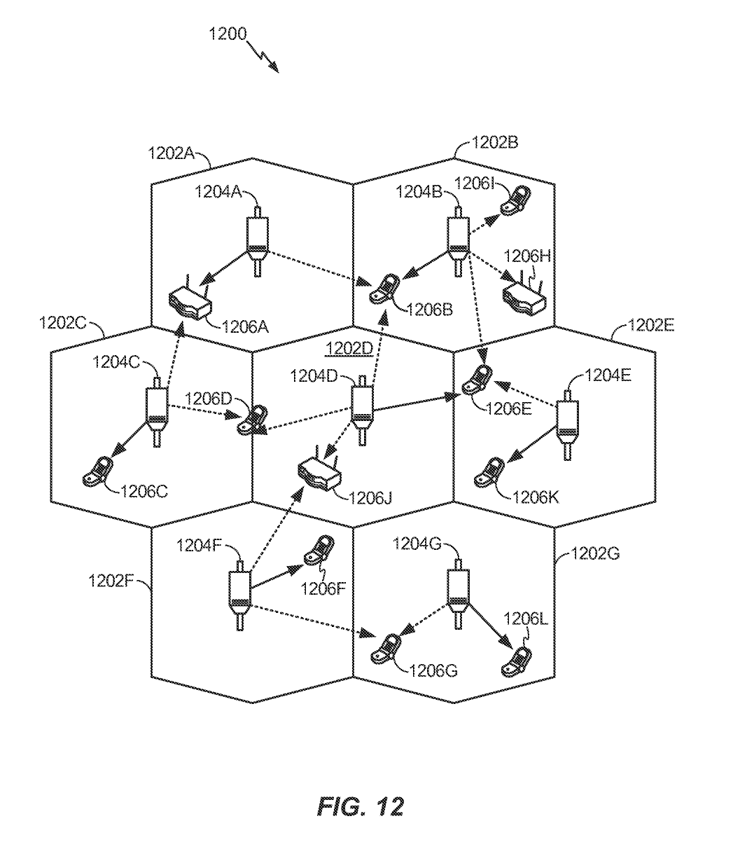

FIG. 12 illustrates a wireless communication system 1200, configured to support a number of users, in which the teachings herein may be implemented. The system 1200 provides communication for multiple cells 1202, such as, for example, macro cells 1202A-1202G, with each cell being serviced by a corresponding access point 1204 (e.g., access points 1204A-1204G). As shown in FIG. 12, access terminals 1206 (e.g., access terminals 1206A-1206L) may be dispersed at various locations throughout the system over time. Each access terminal 1206 may communicate with one or more access points 1204 on a forward link (FL) and/or a reverse link (RL) at a given moment, depending upon whether the access terminal 1206 is active and whether it is in soft handoff, for example. The wireless communication system 1200 may provide service over a large geographic region. For example, macro cells 1202A-1202G may cover a few blocks in a neighborhood or several miles in a rural environment.

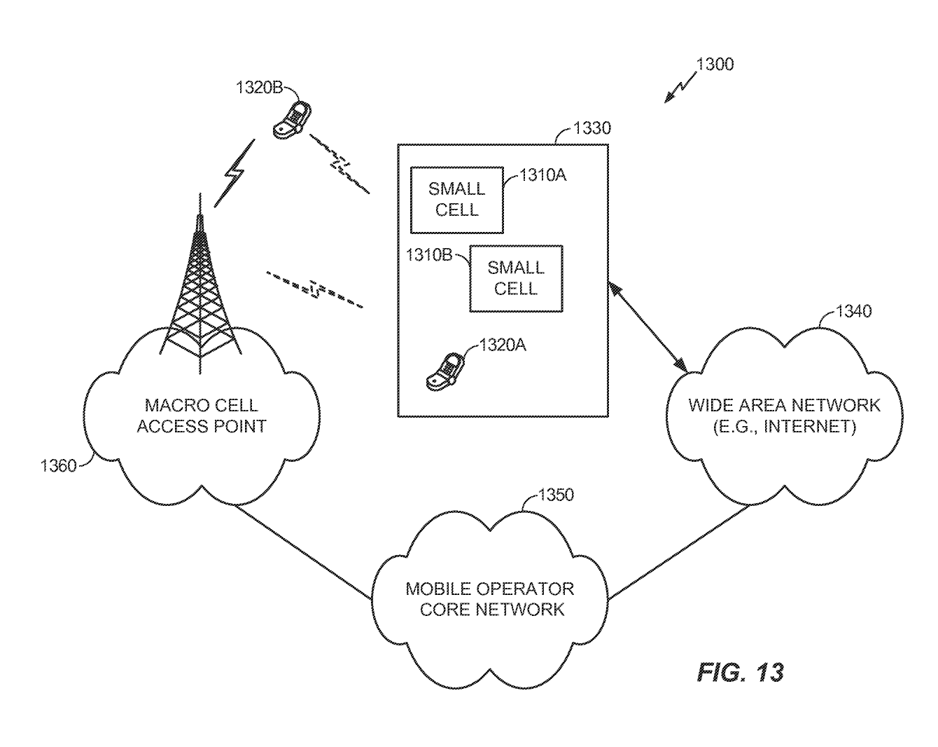

FIG. 13 illustrates an example of a communication system 1300 where one or more small cells are deployed within a network environment. Specifically, the system 1300 includes multiple small cells 1310 (e.g., small cells 1310A and 1310B) installed in a relatively small scale network environment (e.g., in one or more user residences 1330). Each small cell 1310 may be coupled to a wide area network 1340 (e.g., the Internet) and a mobile operator core network 1350 via a DSL router, a cable modem, a wireless link, or other connectivity means (not shown). As will be discussed below, each small cell 1310 may be configured to serve associated access terminals 1320 (e.g., access terminal 1320A) and, optionally, other (e.g., hybrid or alien) access terminals 1320 (e.g., access terminal 1320B). In other words, access to small cells 1310 may be restricted whereby a given access terminal 1320 may be served by a set of designated (e.g., home) small cell(s) 1310 but may not be served by any non-designated small cells 1310 (e.g., a neighbor's small cell 1310).

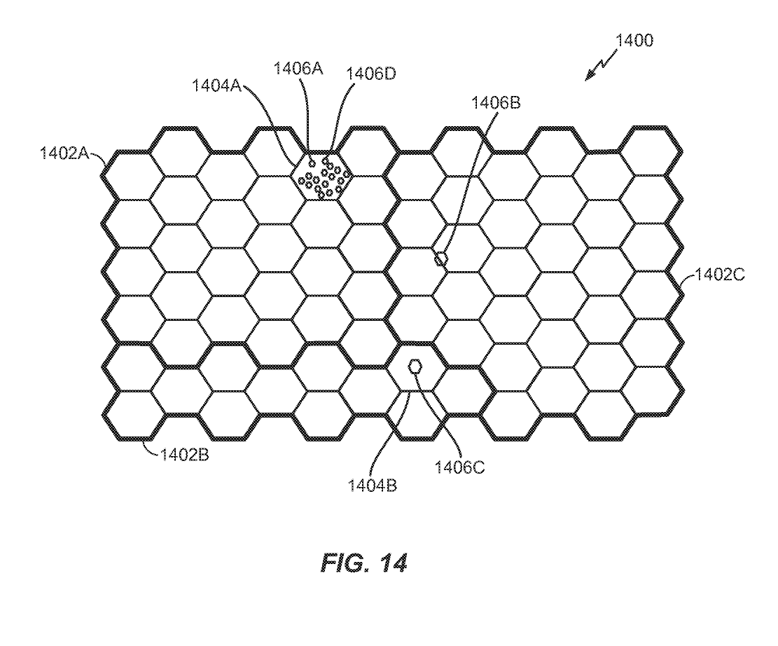

FIG. 14 illustrates an example of a coverage map 1400 where several tracking areas 1402 (or routing areas or location areas) are defined, each of which includes several macro coverage areas 1404. Here, areas of coverage associated with tracking areas 1402A, 1402B, and 1402C are delineated by the wide lines and the macro coverage areas 1404 are represented by the larger hexagons. The tracking areas 1402 also include small cell coverage areas 1406. In this example, each of the small cell coverage areas 1406 (e.g., small cell coverage areas 1406B and 1406C) is depicted within one or more macro coverage areas 1404 (e.g., macro coverage areas 1404A and 1404B). It should be appreciated, however, that some or all of a small cell coverage area 1406 might not lie within a macro coverage area 1404. In practice, a large number of small cell coverage areas 1406 (e.g., small cell coverage areas 1406A and 1406D) may be defined within a given tracking area 1402 or macro coverage area 1404.

Referring again to FIG. 13, the owner of a small cell 1310 may subscribe to mobile service, such as, for example, 3G or 4G mobile service, offered through the mobile operator core network 1350. In addition, an access terminal 1320 may be capable of operating both in macro environments and in smaller scale (e.g., residential) network environments. In other words, depending on the current location of the access terminal 1320, the access terminal 1320 may be served by a macro cell access point 1360 associated with the mobile operator core network 1350 or by any one of a set of small cells 1310 (e.g., the small cells 1310A and 1310B that reside within a corresponding user residence 1330). For example, when a subscriber is outside his home, he is served by a standard macro access point (e.g., access point 1360) and when the subscriber is at home, he is served by a small cell (e.g., small cell 1310A). Here, a small cell 1310 may be backward compatible with legacy access terminals 1320.

A small cell 1310 may be deployed on a single frequency or, in the alternative, on multiple frequencies. Depending on the particular configuration, the single frequency or one or more of the multiple frequencies may overlap with one or more frequencies used by a macro access point (e.g., access point 1360).

In some aspects, an access terminal 1320 may be configured to connect to a preferred small cell (e.g., the home small cell of the access terminal 1320) whenever such connectivity is possible. For example, whenever the access terminal 1320A is within the user's residence 1330, it may be desired that the access terminal 1320A communicate only with the home small cell 1310A or 1310B.

In some aspects, if the access terminal 1320 operates within the macro cellular network 1350 but is not residing on its most preferred network (e.g., as defined in a preferred roaming list), the access terminal 1320 may continue to search for the most preferred network (e.g., the preferred small cell 1310) using a better system reselection (BSR) procedure, which may involve a periodic scanning of available systems to determine whether better systems are currently available and subsequently acquire such preferred systems. The access terminal 1320 may limit the search for a specific band and channel. For example, one or more small cell channels may be defined whereby all small cells (or all restricted small cells) in a region operate on the small cell channel(s). The search for the most preferred system may be repeated periodically. Upon discovery of a preferred small cell 1310, the access terminal 1320 selects the small cell 1310 and registers on it for use when within its coverage area.

Access to a small cell may be restricted in some aspects. For example, a given small cell may only provide certain services to certain access terminals. In deployments with so-called restricted (or closed) access, a given access terminal may only be served by the macro cell mobile network and a defined set of small cells (e.g., the small cells 1310 that reside within the corresponding user residence 1330). In some implementations, an access point may be restricted to not provide, for at least one node (e.g., access terminal), at least one of: signaling, data access, registration, paging, or service.

In some aspects, a restricted small cell (which may also be referred to as a Closed Subscriber Group Home NodeB) is one that provides service to a restricted provisioned set of access terminals. This set may be temporarily or permanently extended as necessary. In some aspects, a Closed Subscriber Group (CSG) may be defined as the set of access points (e.g., small cells) that share a common access control list of access terminals.

Various relationships may thus exist between a given small cell and a given access terminal. For example, from the perspective of an access terminal, an open small cell may refer to a small cell with unrestricted access (e.g., the small cell allows access to any access terminal). A restricted small cell may refer to a small cell that is restricted in some manner (e.g., restricted for access and/or registration). A home small cell may refer to a small cell on which the access terminal is authorized to access and operate on (e.g., permanent access is provided for a defined set of one or more access terminals). A hybrid (or guest) small cell may refer to a small cell on which different access terminals are provided different levels of service (e.g., some access terminals may be allowed partial and/or temporary access while other access terminals may be allowed full access). An alien small cell may refer to a small cell on which the access terminal is not authorized to access or operate on, except for perhaps emergency situations (e.g., 911 calls).

From a restricted small cell perspective, a home access terminal may refer to an access terminal that is authorized to access the restricted small cell installed in the residence of that access terminal's owner (usually the home access terminal has permanent access to that small cell). A guest access terminal may refer to an access terminal with temporary access to the restricted small cell (e.g., limited based on deadline, time of use, bytes, connection count, or some other criterion or criteria). An alien access terminal may refer to an access terminal that does not have permission to access the restricted small cell, except for perhaps emergency situations, for example, such as 911 calls (e.g., an access terminal that does not have the credentials or permission to register with the restricted small cell).

The teachings herein may be employed in a wireless multiple-access communication system that simultaneously supports communication for multiple wireless access terminals. Here, each terminal may communicate with one or more access points via transmissions on the forward and reverse links. The forward link (or downlink) refers to the communication link from the access points to the terminals, and the reverse link (or uplink) refers to the communication link from the terminals to the access points. This communication link may be established via a single-in-single-out system, a multiple-in-multiple-out (MIMO) system, or some other type of system.

A MIMO system employs multiple (N_{T}) transmit antennas and multiple (N_{R}) receive antennas for data transmission. A MIMO channel formed by the N_{T} transmit and N_{R} receive antennas may be decomposed into N_{S} independent channels, which are also referred to as spatial channels, where N_{S}≦min {N_{T}, N_{R}}. Each of the N_{S} independent channels corresponds to a dimension. The MIMO system may provide improved performance (e.g., higher throughput and/or greater reliability) if the additional dimensionalities created by the multiple transmit and receive antennas are utilized.

A MIMO system may support time division duplexing (TDD) and frequency division duplexing (FDD). In a TDD system, the forward and reverse link transmissions are on the same frequency region so that the reciprocity principle allows the estimation of the forward link channel from the reverse link channel. This enables the access point to extract transmit beam-forming gain on the forward link when multiple antennas are available at the access point.

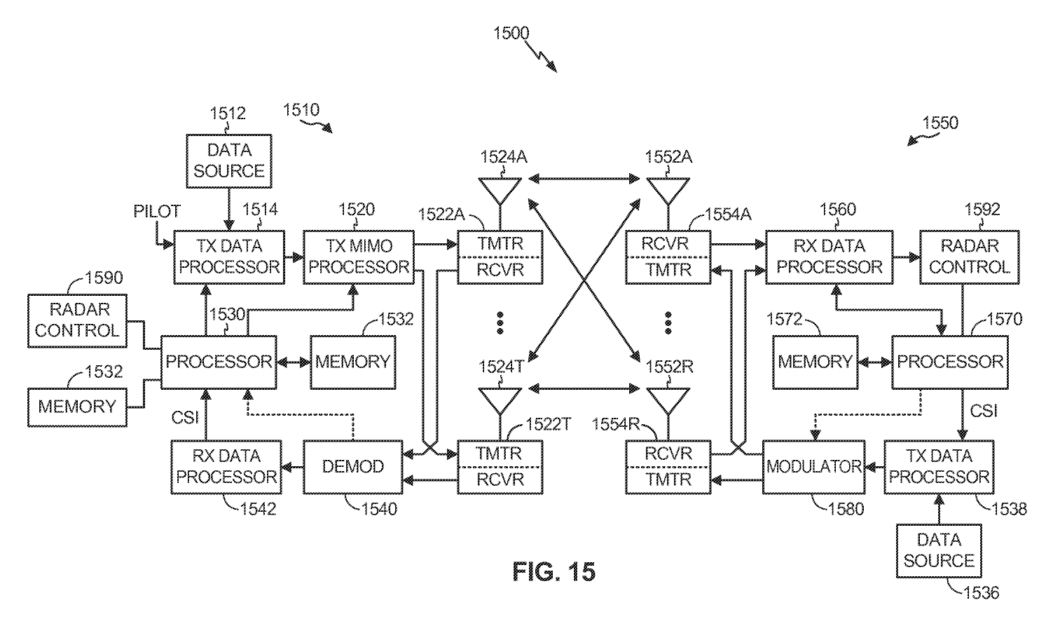

FIG. 15 illustrates a wireless device 1510 (e.g., an access point) and a wireless device 1550 (e.g., an access terminal) of a sample MIMO system 1500. At the device 1510, traffic data for a number of data streams is provided from a data source 1512 to a transmit (TX) data processor 1514. Each data stream may then be transmitted over a respective transmit antenna.

The TX data processor 1514 formats, codes, and interleaves the traffic data for each data stream based on a particular coding scheme selected for that data stream to provide coded data. The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (i.e., symbol mapped) based on a particular modulation scheme (e.g., BPSK, QSPK, M-PSK, or M-QAM) selected for that data stream to provide modulation symbols. The data rate, coding, and modulation for each data stream may be determined by instructions performed by a processor 1530. A data memory 1532 may store program code, data, and other information used by the processor 1530 or other components of the device 1510.

The modulation symbols for all data streams are then provided to a TX MIMO processor 1520, which may further process the modulation symbols (e.g., for OFDM). The TX MIMO processor 1520 then provides N_{T} modulation symbol streams to N_{T} transceivers (XCVR) 1522A through 1522T. In some aspects, the TX MIMO processor 1520 applies beam-forming weights to the symbols of the data streams and to the antenna from which the symbol is being transmitted.

Each transceiver 1522 receives and processes a respective symbol stream to provide one or more analog signals, and further conditions (e.g., amplifies, filters, and upconverts) the analog signals to provide a modulated signal suitable for transmission over the MIMO channel. N_{T} modulated signals from transceivers 1522A through 1522T are then transmitted from N_{T} antennas 1524A through 1524T, respectively.

At the device 1550, the transmitted modulated signals are received by N_{R} antennas 1552A through 1552R and the received signal from each antenna 1552 is provided to a respective transceiver (XCVR) 1554A through 1554R. Each transceiver 1554 conditions (e.g., filters, amplifies, and downconverts) a respective received signal, digitizes the conditioned signal to provide samples, and further processes the samples to provide a corresponding “received” symbol stream.

A receive (RX) data processor 1560 then receives and processes the N_{R} received symbol streams from N_{R} transceivers 1554 based on a particular receiver processing technique to provide N_{T} “detected” symbol streams. The RX data processor 1560 then demodulates, deinterleaves, and decodes each detected symbol stream to recover the traffic data for the data stream. The processing by the RX data processor 1560 is complementary to that performed by the TX MIMO processor 1520 and the TX data processor 1514 at the device 1510.

A processor 1570 periodically determines which pre-coding matrix to use (discussed below). The processor 1570 formulates a reverse link message comprising a matrix index portion and a rank value portion. A data memory 1572 may store program code, data, and other information used by the processor 1570 or other components of the device 1550.

The reverse link message may comprise various types of information regarding the communication link and/or the received data stream. The reverse link message is then processed by a TX data processor 1538, which also receives traffic data for a number of data streams from a data source 1536, modulated by a modulator 1580, conditioned by the transceivers 1554A through 1554R, and transmitted back to the device 1510.

At the device 1510, the modulated signals from the device 1550 are received by the antennas 1524, conditioned by the transceivers 1522, demodulated by a demodulator (DEMOD) 1540, and processed by a RX data processor 1542 to extract the reverse link message transmitted by the device 1550. The processor 1530 then determines which pre-coding matrix to use for determining the beam-forming weights then processes the extracted message.

FIG. 15 also illustrates that the communication components may include one or more components that perform radar detection operations as taught herein. For example, a radar control component 1590 may cooperate with the processor 1530 and/or other components of the device 1510 to detect radar as taught herein. Similarly, a radar control component 1592 may cooperate with the processor 1570 and/or other components of the device 1550 to detect radar as taught herein. It should be appreciated that for each device 1510 and 1550 the functionality of two or more of the described components may be provided by a single component. For example, a single processing component may provide the functionality of the radar control component 1590 and the processor 1530 and a single processing component may provide the functionality of the radar control component 1592 and the processor 1570.

The teachings herein may be incorporated into various types of communication systems and/or system components. In some aspects, the teachings herein may be employed in a multiple-access system capable of supporting communication with multiple users by sharing the available system resources (e.g., by specifying one or more of bandwidth, transmit power, coding, interleaving, and so on). For example, the teachings herein may be applied to any one or combinations of the following technologies: Code Division Multiple Access (CDMA) systems, Multiple-Carrier CDMA (MCCDMA), Wideband CDMA (W-CDMA), High-Speed Packet Access (HSPA, HSPA+) systems, Time Division Multiple Access (TDMA) systems, Frequency Division Multiple Access (FDMA) systems, Single-Carrier FDMA (SC-FDMA) systems, Orthogonal Frequency Division Multiple Access (OFDMA) systems, or other multiple access techniques. A wireless communication system employing the teachings herein may be designed to implement one or more standards, such as IS-95, cdma2000, IS-856, W-CDMA, TDSCDMA, and other standards. A CDMA network may implement a radio technology such as Universal Terrestrial Radio Access (UTRA), cdma2000, or some other technology. UTRA includes W-CDMA and Low Chip Rate (LCR). The cdma2000 technology covers IS-2000, IS-95 and IS-856 standards. A TDMA network may implement a radio technology such as Global System for Mobile Communications (GSM). An OFDMA network may implement a radio technology such as Evolved UTRA (E-UTRA), IEEE 802.11, IEEE 802.16, IEEE 802.20, Flash-OFDM®, etc. UTRA, E-UTRA, and GSM are part of Universal Mobile Telecommunication System (UMTS). The teachings herein may be implemented in a 3GPP Long Term Evolution (LTE) system, an Ultra-Mobile Broadband (UMB) system, and other types of systems. LTE is a release of UMTS that uses E-UTRA. UTRA, E-UTRA, GSM, UMTS and LTE are described in documents from an organization named “3rd Generation Partnership Project” (3GPP), while cdma2000 is described in documents from an organization named “3rd Generation Partnership Project 2” (3GPP2). Although certain aspects of the disclosure may be described using 3GPP terminology, it is to be understood that the teachings herein may be applied to 3GPP (e.g., Re199, Re15, Re16, Re17) technology, as well as 3GPP2 (e.g., 1xRTT, 1xEV-DO Re10, RevA, RevB) technology and other technologies.

The teachings herein may be incorporated into (e.g., implemented within or performed by) a variety of apparatuses (e.g., nodes). In some aspects, a node (e.g., a wireless node) implemented in accordance with the teachings herein may comprise an access point or an access terminal.

For example, an access terminal may comprise, be implemented as, or known as user equipment, a subscriber station, a subscriber unit, a mobile station, a mobile, a mobile node, a remote station, a remote terminal, a user terminal, a user agent, a user device, or some other terminology. In some implementations, an access terminal may comprise a cellular telephone, a cordless telephone, a session initiation protocol (SIP) phone, a wireless local loop (WLL) station, a personal digital assistant (PDA), a handheld device having wireless connection capability, or some other suitable processing device connected to a wireless modem. Accordingly, one or more aspects taught herein may be incorporated into a phone (e.g., a cellular phone or smart phone), a computer (e.g., a laptop), a tablet, a portable communication device, a portable computing device (e.g., a personal data assistant), an entertainment device (e.g., a music device, a video device, or a satellite radio), a global positioning system device, or any other suitable device that is configured to communicate via a wireless medium.

An access point may comprise, be implemented as, or known as a NodeB, an eNodeB, a radio network controller (RNC), a base station (BS), a radio base station (RBS), a base station controller (BSC), a base transceiver station (BTS), a transceiver function (TF), a radio transceiver, a radio router, a basic service set (BSS), an extended service set (ESS), a macro cell, a macro node, a Home eNB (HeNB), a femto cell, a femto node, a pico node, or some other similar terminology.

In some aspects, a node (e.g., an access point) may comprise an access node for a communication system. Such an access node may provide, for example, connectivity for or to a network (e.g., a wide area network such as the Internet or a cellular network) via a wired or wireless communication link to the network. Accordingly, an access node may enable another node (e.g., an access terminal) to access a network or some other functionality. In addition, it should be appreciated that one or both of the nodes may be portable or, in some cases, relatively non-portable.

Also, it should be appreciated that a wireless node may be capable of transmitting and/or receiving information in a non-wireless manner (e.g., via a wired connection). Thus, a receiver and a transmitter as discussed herein may include appropriate communication interface components (e.g., electrical or optical interface components) to communicate via a non-wireless medium.

A wireless node may communicate via one or more wireless communication links that are based on or otherwise support any suitable wireless communication technology. For example, in some aspects a wireless node may associate with a network. In some aspects, the network may comprise a local area network or a wide area network. A wireless device may support or otherwise use one or more of a variety of wireless communication technologies, protocols, or standards such as those discussed herein (e.g., CDMA, TDMA, OFDM, OFDMA, WiMAX, Wi-Fi, and so on). Similarly, a wireless node may support or otherwise use one or more of a variety of corresponding modulation or multiplexing schemes. A wireless node may thus include appropriate components (e.g., air interfaces) to establish and communicate via one or more wireless communication links using the above or other wireless communication technologies. For example, a wireless node may comprise a wireless transceiver with associated transmitter and receiver components that may include various components (e.g., signal generators and signal processors) that facilitate communication over a wireless medium.

The functionality described herein (e.g., with regard to one or more of the accompanying figures) may correspond in some aspects to similarly designated “means for” functionality in the appended claims.

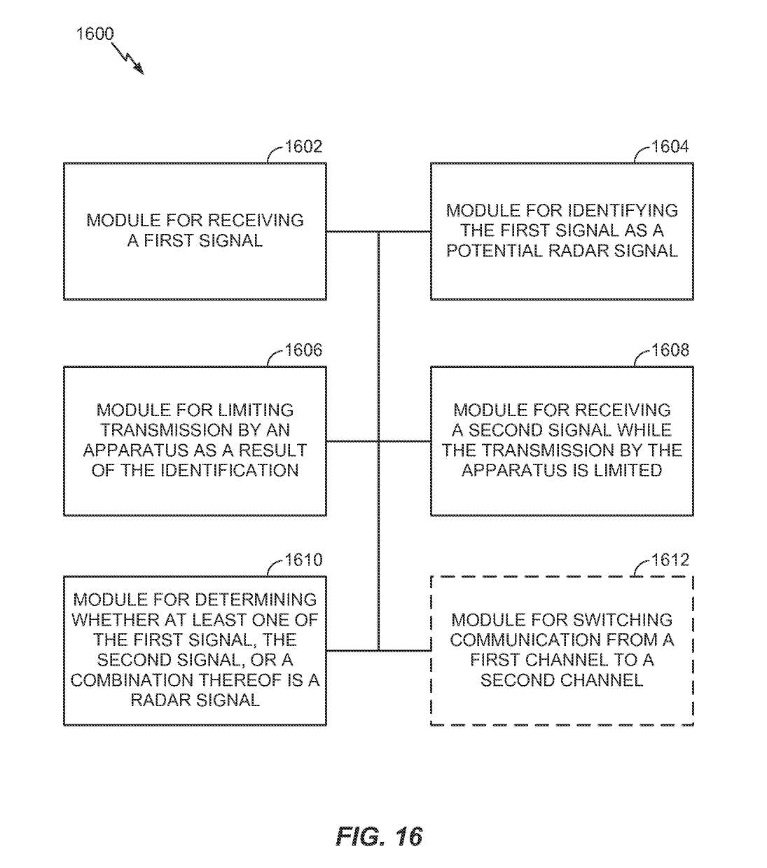

Referring to FIG. 16, an apparatus 1600 is represented as a series of interrelated functional modules. A module for receiving a first signal 1602 may correspond at least in some aspects to, for example, a communication device (e.g., a receiver) as discussed herein. A module for identifying the first signal as a potential radar signal 1604 may correspond at least in some aspects to, for example, a processing system as discussed herein. A module for limiting transmission by an apparatus as a result of the identification 1606 may correspond at least in some aspects to, for example, a processing system as discussed herein. A module for receiving a second signal while the transmission by the apparatus is limited 1608 may correspond at least in some aspects to, for example, a communication device (e.g., a receiver) as discussed herein. A module for determining whether at least one of the first signal or the second signal is a radar signal 1610 may correspond at least in some aspects to, for example, a processing system as discussed herein. A module for determining whether to switch communication from a first channel to a second channel 1612 may correspond at least in some aspects to, for example, a processing system as discussed herein.

The functionality of the modules of FIG. 16 may be implemented in various ways consistent with the teachings herein. In some aspects, the functionality of these modules may be implemented as one or more electrical components. In some aspects, the functionality of these blocks may be implemented as a processing system including one or more processor components. In some aspects, the functionality of these modules may be implemented using, for example, at least a portion of one or more integrated circuits (e.g., an ASIC). As discussed herein, an integrated circuit may include a processor, software, other related components, or some combination thereof. Thus, the functionality of different modules may be implemented, for example, as different subsets of an integrated circuit, as different subsets of a set of software modules, or a combination thereof. Also, it should be appreciated that a given subset (e.g., of an integrated circuit and/or of a set of software modules) may provide at least a portion of the functionality for more than one module. As one specific example, the apparatus 1600 may comprise a single device (e.g., components 1602-1612 comprising different sections of an ASIC). As another specific example, the apparatus 1600 may comprise several devices (e.g., the components 1602 and 1608 comprising one ASIC and the components 1604, 1606, 1610, and 1612 comprising another ASIC). The functionality of these modules also may be implemented in some other manner as taught herein. In some aspects one or more of any dashed blocks in FIG. 16 are optional.

In addition, the components and functions represented by FIG. 16 as well as other components and functions described herein, may be implemented using any suitable means. Such means also may be implemented, at least in part, using corresponding structure as taught herein. For example, the components described above in conjunction with the “module for” components of FIG. 16 also may correspond to similarly designated “means for” functionality. Thus, in some aspects one or more of such means may be implemented using one or more of processor components, integrated circuits, or other suitable structure as taught herein.

In some aspects, an apparatus or any component of an apparatus may be configured to (or operable to or adapted to) provide functionality as taught herein. This may be achieved, for example: by manufacturing (e.g., fabricating) the apparatus or component so that it will provide the functionality; by programming the apparatus or component so that it will provide the functionality; or through the use of some other suitable implementation technique. As one example, an integrated circuit may be fabricated to provide the requisite functionality. As another example, an integrated circuit may be fabricated to support the requisite functionality and then configured (e.g., via programming) to provide the requisite functionality. As yet another example, a processor circuit may execute code to provide the requisite functionality.

It should be understood that any reference to an element herein using a designation such as “first,” “second,” and so forth does not generally limit the quantity or order of those elements. Rather, these designations may be used herein as a convenient method of distinguishing between two or more elements or instances of an element. Thus, a reference to first and second elements does not mean that only two elements may be employed there or that the first element must precede the second element in some manner. Also, unless stated otherwise a set of elements may comprise one or more elements. In addition, terminology of the form “at least one of A, B, or C” or “one or more of A, B, or C” or “at least one of the group consisting of A, B, and C” used in the description or the claims means “A or B or C or any combination of these elements.” For example, this terminology may include A, or B, or C, or A and B, or A and C, or A and B and C, or 2A, or 2B, or 2C, and so on.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill will further appreciate that any of the various illustrative logical blocks, modules, processors, means, circuits, and algorithm operations described in connection with the aspects disclosed herein may be implemented as electronic hardware (e.g., a digital implementation, an analog implementation, or a combination of the two, which may be designed using source coding or some other technique), various forms of program or design code incorporating instructions (which may be referred to herein, for convenience, as “software” or a “software module”), or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented within or performed by a processing system, an integrated circuit (“IC”), an access terminal, or an access point. A processing system may be implemented using one or more ICs or may be implemented within an IC (e.g., as part of a system on a chip). An IC may comprise a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and may execute codes or instructions that reside within the IC, outside of the IC, or both. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

It will be understood that any specific order or hierarchy of operations in any disclosed process is an example of a sample approach. Based upon design preferences, it will be understood that the specific order or hierarchy of operations in the processes may be rearranged while remaining within the scope of the present disclosure. The accompanying method claims present elements of the various operations in a sample order, and are not meant to be limited to the specific order or hierarchy presented.

The operations of a method or algorithm described in connection with the aspects disclosed herein may be embodied directly in hardware, in a software module executed by a processor, or in a combination of the two. A software module (e.g., including executable instructions and related data) and other data may reside in a memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such that the processor can read information (e.g., code) from and write information to the storage medium. A sample storage medium may be integral to the processor. The processor and the storage medium may reside in an ASIC. The ASIC may reside in user equipment. In the alternative, the processor and the storage medium may reside as discrete components in user equipment. Moreover, in some aspects any suitable computer-program product may comprise a computer-readable medium comprising code(s) executable (e.g., executable by at least one computer) to provide functionality relating to one or more of the aspects of the disclosure. In some aspects, a computer program product may comprise packaging materials.

In one or more implementations, the functions described may be implemented in hardware, software, firmware, or any combination thereof. If implemented in software, the functions may be stored on or transmitted over as one or more instructions or code on a computer-readable medium. Computer-readable media include both computer storage media and communication media including any medium that facilitates transfer of a computer program from one place to another. A computer-readable medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and blu-ray disc, where disks usually reproduce data magnetically and discs reproduce data optically with lasers. Thus, in some aspects, computer-readable media may comprise non-transitory computer-readable media (e.g., tangible media, computer-readable storage media, computer-readable storage devices, etc.). Such a non-transitory computer-readable medium (e.g., computer-readable storage device) may comprise any of the tangible forms of media described herein or otherwise known (e.g., a memory device, a media disk, etc.). In addition, in some aspects, computer-readable media may comprise transitory computer readable media (e.g., comprising a signal). Combinations of the above should also be included within the scope of computer-readable media. It should be appreciated that a computer-readable medium may be implemented in any suitable computer-program product.

As used herein, the term “determining” encompasses a wide variety of actions. For example, “determining” may include calculating, computing, processing, deriving, investigating, looking up (e.g., looking up in a table, a database or another data structure), ascertaining, and the like. Also, “determining” may include receiving (e.g., receiving information), accessing (e.g., accessing data in a memory), and the like. Also, “determining” may include resolving, selecting, choosing, establishing, and the like.

The previous description of the disclosed aspects is provided to enable any person skilled in the art to make and use the various implementations of the present disclosure. Various modifications to certain aspects will be readily apparent to those skilled in the art, and the generic principles defined herein may be applied to other aspects without departing from the scope of the disclosure. Thus, the present disclosure is not intended to be limited to the aspects shown herein but is to be accorded the widest scope consistent with the principles and novel features disclosed herein.

What is claimed is:

1. A method of radar detection in a communication environment, comprising:
receiving a first signal;
identifying the first signal as a potential radar signal;
limiting transmission by an apparatus as a result of the identification;
receiving a second signal while the transmission by the apparatus is limited; and
determining whether at least one of the first signal, the second signal, or a combination thereof is a radar signal.

2. The method of claim 1, wherein:
the identification of the first signal as a potential radar signal comprises detecting at least one potential radar pulse; and
the determination of whether at least one of the first signal, the second signal, or a combination thereof is a radar signal comprises detecting a radar pulse burst pattern.

3. The method of claim 1, wherein:
the identification of the first signal as a potential radar signal comprises a preliminary determination that radar signals are being received; and
the determination of whether at least one of the first signal, the second signal, or a combination thereof is a radar signal comprises a final determination that radar signals are being received.

4. The method of claim 1, wherein the limitation of transmission comprises transmitting a message to the apparatus requesting that the apparatus limit transmission.

5. The method of claim 1, wherein the limitation of transmission comprises at least one of:
ceasing scheduling of transmissions for the apparatus;
ceasing issuance of grants in response to requests to schedule transmissions received from the apparatus;
reducing transmit power of the apparatus;
limiting resources for transmissions by the apparatus;
switching from periodic channel quality reporting to aperiodic channel quality reporting; or
reducing a transmit-to-receive duty cycle for time division duplex communication.

6. The method of claim 1, wherein the identification of the first signal as a potential radar signal comprises determining whether a defined quantity of pulses were received within a defined period of time.

7. The method of claim 1, wherein the identification of the first signal as a potential radar signal comprises at least one of:
determining whether a bandwidth characteristic of the first signal corresponds to a bandwidth characteristic of a radar pulse; or
determining whether a frequency characteristic of the first signal corresponds to a frequency characteristic of a radar pulse.

8. The method of claim 1, wherein the determination of the first signal as a potential radar signal comprises at least one of:
determining whether a received signal strength characteristic of the first signal corresponds to a received signal strength characteristic of a radar signal;
determining whether a pulse width characteristic of the first signal corresponds to a pulse width characteristic of a radar signal;
determining whether a pulse repetition interval characteristic of the first signal corresponds to a pulse repetition interval characteristic of a radar signal; or
determining whether a chirp characteristic of the first signal corresponds to a chirp characteristic of a radar signal.

9. The method of claim 1, wherein the determination of whether at least one of the first signal, the second signal, or a combination thereof is a radar signal comprises at least one of:
determining whether a bandwidth characteristic of the first signal, the second signal, or a combination thereof corresponds to a bandwidth characteristic of a radar pulse;
determining whether a frequency characteristic of the first signal, the second signal, or a combination thereof corresponds to a frequency characteristic of a radar pulse;
determining whether a received signal strength characteristic of the first signal, the second signal, or a combination thereof corresponds to a received signal strength characteristic of a radar signal;
determining whether a pulse width characteristic of the first signal, the second signal, or a combination thereof corresponds to a pulse width characteristic of a radar signal;
determining whether a pulse repetition interval characteristic of the first signal, the second signal, or a combination thereof corresponds to a pulse repetition interval characteristic of a radar signal; or
determining whether a chirp characteristic of the first signal, the second signal, or a combination thereof corresponds to a chirp characteristic of a radar signal.

10. The method of claim 1, further comprising switching communication from a first channel to a second channel based on the determination of whether at least one of the first signal, the second signal, or a combination thereof is a radar signal.

11. An apparatus for radar detection in a communication environment, comprising:
a receiver configured to receive a first signal;
a processor configured to:
identify the first signal as a potential radar signal, and
limit transmission by an apparatus as a result of the identification;
wherein:
the receiver is further configured to receive a second signal while the transmission by the apparatus is limited, and
the processor is further configured to determine whether at least one of the first signal, the second signal, or a combination thereof is a radar signal.

12. The apparatus of claim 11, wherein:
the processor is configured to identify the first signal as a potential radar signal by detecting at least one potential radar pulse; and
the processor is configured to determine whether at least one of the first signal, the second signal, or a combination thereof is a radar signal by detecting a radar pulse burst pattern.

13. The apparatus of claim 11, wherein:
the processor is configured to identify the first signal as a potential radar signal by making a preliminary determination that radar signals are being received; and
the processor is configured to determine whether at least one of the first signal, the second signal, or a combination thereof is a radar signal by making a final determination that radar signals are being received.

14. The apparatus of claim 11, wherein the processor is configured to limit transmission by causing a transmitter to transmit a message to the apparatus requesting that the apparatus limit transmission.

15. The apparatus of claim 11, wherein the processor is configured to limit transmission by at least one of:
ceasing scheduling of transmissions for the apparatus;
ceasing issuance of grants in response to requests to schedule transmissions received from the apparatus;
reducing transmit power of the apparatus;
limiting resources for transmissions by the apparatus;
switching from periodic channel quality reporting to aperiodic channel quality reporting; or
reducing a transmit-to-receive duty cycle for time division duplex communication.

16. The apparatus of claim 11, wherein the processor is configured to identify the first signal as a potential radar signal by determining whether a defined quantity of pulses were received within a defined period of time.

17. The apparatus of claim 11, wherein the processor is configured to identify the first signal as a potential radar signal by at least one of:
determining whether a bandwidth characteristic of the first signal corresponds to a bandwidth characteristic of a radar pulse; or
determining whether a frequency characteristic of the first signal corresponds to a frequency characteristic of a radar pulse.

18. The apparatus of claim 11, wherein the processor is configured to determine the first signal as a potential radar signal by at least one of:
determining whether a received signal strength characteristic of the first signal corresponds to a received signal strength characteristic of a radar signal;
determining whether a pulse width characteristic of the first signal corresponds to a pulse width characteristic of a radar signal;
determining whether a pulse repetition interval characteristic of the first signal corresponds to a pulse repetition interval characteristic of a radar signal; or
determining whether a chirp characteristic of the first signal corresponds to a chirp characteristic of a radar signal.

19. The apparatus of claim 11, wherein the processor is configured to determine whether at least one of the first signal, the second signal, or a combination thereof is a radar signal by at least one of:
determining whether a bandwidth characteristic of the first signal, the second signal, or a combination thereof corresponds to a bandwidth characteristic of a radar pulse;
determining whether a frequency characteristic of the first signal, the second signal, or a combination thereof corresponds to a frequency characteristic of a radar pulse;
determining whether a received signal strength characteristic of the first signal, the second signal, or a combination thereof corresponds to a received signal strength characteristic of a radar signal;
determining whether a pulse width characteristic of the first signal, the second signal, or a combination thereof corresponds to a pulse width characteristic of a radar signal;
determining whether a pulse repetition interval characteristic of the first signal, the second signal, or a combination thereof corresponds to a pulse repetition interval characteristic of a radar signal; or
determining whether a chirp characteristic of the first signal, the second signal, or a combination thereof corresponds to a chirp characteristic of a radar signal.

20. The apparatus of claim 11, wherein the processor is further configured to switch communication from a first channel to a second channel based on the determination of whether at least one of the first signal, the second signal, or a combination thereof is a radar signal.

21. An apparatus for radar detection in a communication environment, comprising:
means for receiving a first signal;
means for identifying the first signal as a potential radar signal;
means for limiting transmission by an apparatus as a result of the identification;
means for receiving a second signal while the transmission by the apparatus is limited; and
means for determining whether at least one of the first signal, the second signal, or a combination thereof is a radar signal.

22. The apparatus of claim 21, wherein:
the means for identifying the first signal as a potential radar signal comprises means for detecting at least one potential radar pulse; and
the means for determining whether at least one of the first signal, the second signal, or a combination thereof is a radar signal comprises means for detecting a radar pulse burst pattern.

23. The apparatus of claim 21, wherein:
the means for identifying the first signal as a potential radar signal comprises means for making a preliminary determination that radar signals are being received; and
the means for determining whether at least one of the first signal, the second signal, or a combination thereof is a radar signal comprises means for making a final determination that radar signals are being received.

24. The apparatus of claim 21, wherein the means for limiting transmission comprises means for transmitting a message to the apparatus requesting that the apparatus limit transmission.

25. The apparatus of claim 21, wherein the means for limiting transmission comprises at least one of:
means for ceasing scheduling of transmissions for the apparatus;
means for ceasing issuance of grants in response to requests to schedule transmissions received from the apparatus;
means for reducing transmit power of the apparatus;
means for limiting resources for transmissions by the apparatus;
means for switching from periodic channel quality reporting to aperiodic channel quality reporting; or
means for reducing a transmit-to-receive duty cycle for time division duplex communication.

26. The apparatus of claim 21, wherein means for identifying the first signal as a potential radar signal comprises means for determining whether a defined quantity of pulses were received within a defined period of time.

27. The apparatus of claim 21, wherein the means for identifying the first signal as a potential radar signal comprises at least one of:
means for determining whether a bandwidth characteristic of the first signal corresponds to a bandwidth characteristic of a radar pulse; or
means for determining whether a frequency characteristic of the first signal corresponds to a frequency characteristic of a radar pulse.

28. The apparatus of claim 21, wherein the means for determining the first signal as a potential radar signal comprises at least one of:
means for determining whether a received signal strength characteristic of the first signal corresponds to a received signal strength characteristic of a radar signal;
means for determining whether a pulse width characteristic of the first signal corresponds to a pulse width characteristic of a radar signal;
means for determining whether a pulse repetition interval characteristic of the first signal corresponds to a pulse repetition interval characteristic of a radar signal; or
means for determining whether a chirp characteristic of the first signal corresponds to a chirp characteristic of a radar signal.

29. The apparatus of claim 21, wherein the means for determining whether at least one of the first signal, the second signal, or a combination thereof is a radar signal comprises at least one of:
means for determining whether a bandwidth characteristic of the first signal, the second signal, or a combination thereof corresponds to a bandwidth characteristic of a radar pulse;
means for determining whether a frequency characteristic of the first signal, the second signal, or a combination thereof corresponds to a frequency characteristic of a radar pulse;
means for determining whether a received signal strength characteristic of the first signal, the second signal, or a combination thereof corresponds to a received signal strength characteristic of a radar signal;
means for determining whether a pulse width characteristic of the first signal, the second signal, or a combination thereof corresponds to a pulse width characteristic of a radar signal;
means for determining whether a pulse repetition interval characteristic of the first signal, the second signal, or a combination thereof corresponds to a pulse repetition interval characteristic of a radar signal; or
means for determining whether a chirp characteristic of the first signal, the second signal, or a combination thereof corresponds to a chirp characteristic of a radar signal.

30. The apparatus of claim 21, further comprising means for switching communication from a first channel to a second channel based on the determination of whether at least one of the first signal, the second signal, or a combination thereof is a radar signal.

31. A non-transitory computer-readable medium comprising instructions, which, when executed by a processor, causes the process to perform operations for radar detection in a communication environment, the non-transitory computer-readable medium comprising:
instructions for receiving a first signal;
instructions for identifying the first signal as a potential radar signal;
instructions for limiting transmission by an non-transitory computer-readable medium as a result of the identification;
instructions for receiving a second signal while the transmission by the non-transitory computer-readable medium is limited; and
instructions for determining whether at least one of the first signal, the second signal, or a combination thereof is a radar signal.

32. The non-transitory computer-readable medium of claim 31, wherein:
the instructions for identifying the first signal as a potential radar signal comprise instructions for detecting at least one potential radar pulse; and
the instructions for determining whether at least one of the first signal, the second signal, or a combination thereof is a radar signal comprise instructions for detecting a radar pulse burst pattern.

33. The non-transitory computer-readable medium of claim 31, wherein:
the instructions for identifying the first signal as a potential radar signal comprise instructions for making a preliminary determination that radar signals are being received; and
the instructions for determining whether at least one of the first signal, the second signal, or a combination thereof is a radar signal comprise instructions for making a final determination that radar signals are being received.

34. The non-transitory computer-readable medium of claim 31, wherein the instructions for limiting transmission comprise instructions for transmitting a message to the non-transitory computer-readable medium requesting that the non-transitory computer-readable medium limit transmission.

35. The non-transitory computer-readable medium of claim 31, wherein the instructions for limiting transmission comprises at least one of:
instructions for ceasing scheduling of transmissions for the non-transitory computer-readable medium;
instructions for ceasing issuance of grants in response to requests to schedule transmissions received from the non-transitory computer-readable medium;
instructions for reducing transmit power of the non-transitory computer-readable medium;
instructions for limiting resources for transmissions by the non-transitory computer-readable medium;
instructions for switching from periodic channel quality reporting to aperiodic channel quality reporting; or
instructions for reducing a transmit-to-receive duty cycle for time division duplex communication.

36. The non-transitory computer-readable medium of claim 31, wherein instructions for identifying the first signal as a potential radar signal comprise instructions for determining whether a defined quantity of pulses were received within a defined period of time.

37. The non-transitory computer-readable medium of claim 31, wherein the instructions for identifying the first signal as a potential radar signal comprises at least one of:
instructions for determining whether a bandwidth characteristic of the first signal corresponds to a bandwidth characteristic of a radar pulse; or
instructions for determining whether a frequency characteristic of the first signal corresponds to a frequency characteristic of a radar pulse.

38. The non-transitory computer-readable medium of claim 31, wherein the instructions for determining the first signal as a potential radar signal comprises at least one of:
instructions for determining whether a received signal strength characteristic of the first signal corresponds to a received signal strength characteristic of a radar signal;
instructions for determining whether a pulse width characteristic of the first signal corresponds to a pulse width characteristic of a radar signal;
instructions for determining whether a pulse repetition interval characteristic of the first signal corresponds to a pulse repetition interval characteristic of a radar signal; or
instructions for determining whether a chirp characteristic of the first signal corresponds to a chirp characteristic of a radar signal.

39. The non-transitory computer-readable medium of claim 31, wherein the instructions for determining whether at least one of the first signal, the second signal, or a combination thereof is a radar signal comprises at least one of:
instructions for determining whether a bandwidth characteristic of the first signal, the second signal, or a combination thereof corresponds to a bandwidth characteristic of a radar pulse;
instructions for determining whether a frequency characteristic of the first signal, the second signal, or a combination thereof corresponds to a frequency characteristic of a radar pulse;
instructions for determining whether a received signal strength characteristic of the first signal, the second signal, or a combination thereof corresponds to a received signal strength characteristic of a radar signal;
instructions for determining whether a pulse width characteristic of the first signal, the second signal, or a combination thereof corresponds to a pulse width characteristic of a radar signal;
instructions for determining whether a pulse repetition interval characteristic of the first signal, the second signal, or a combination thereof corresponds to a pulse repetition interval characteristic of a radar signal; or
instructions for determining whether a chirp characteristic of the first signal, the second signal, or a combination thereof corresponds to a chirp characteristic of a radar signal.

40. The non-transitory computer-readable medium of claim 31, further comprising instructions for switching communication from a first channel to a second channel based on the determination of whether at least one of the first signal, the second signal, or a combination thereof is a radar signal.
